(19) United States
(12) Patent Application Publication
(10) Pub. No.: US 2025/0390941 A1
(43) Pub. Date: Dec. 25, 2025

(54) SYSTEMS AND METHODS FOR PROVIDING FLEXIBLE LIMIT SHARE ACCOUNTS

(71) Applicant: Wells Fargo Bank, N.A., San Francisco, CA (US)

(72) Inventors: Michelle W. Chan, San Francisco, CA (US); Robin H. Lo, San Francisco, CA (US); Young M. Yang, San Francisco, CA (US)

(21) Appl. No.: 18/750,476

(22) Filed: Jun. 21, 2024

(51) Int. Cl. G06Q 40/02; G06Q 20/36; G06Q 20/40

(52) U.S. Cl. CPC G06Q 40/02; G06Q 20/36; G06Q 20/4014; G06Q 2220/00

(57) ABSTRACT

Systems, apparatuses, methods, and computer program products are disclosed for providing a flexible limit share account (FLSA) to one or more smart mobile wallets associated designated and/or secondary users. An example method includes generating an FLSA associated with an existing payment account of a primary user, where the FLSA may be utilizable only in alignment with various predetermined conditions set forth by the primary user. The example method further includes authenticating, based on an FLSA share request, the primary user and at least one designated user based on a first mobile driver’s license (mDL) associated with the primary user and a second mDL associated with the designated user. The example method further includes providing the FLSA to a smart mobile wallet associated with the designated user such that the FLSA may be utilized to complete various types of approved transactions.

### BACKGROUND

Accessing payment accounts via mobile computing devices is often desirable while executing various transactions. However, conventional payment systems and techniques exhibit numerous drawbacks, inefficiencies, and limitations.

### BRIEF SUMMARY

Conventional payment systems (e.g., as provided by banks or financial institutions) may allow family members associated with a primary user to access funds and/or a payment account of the primary user. However, enterprises have not had an efficient, effective way to securely set up temporary spending accounts for secondary trusted, or “designated,” users. Additionally, enterprises have not had an efficient or secure way to authenticate secondary users that may not be related to the primary user and/or have not been previously associated with an existing payment account of the primary user. Furthermore, the conventional means for providing temporary access to funds to secondary users is limited and may result in high costs, wasted technological resources due to computational complexity, and insecure means of ensuring the safe transfer and/or access to temporary funds.

For example, various enterprises (e.g., financial institutions) may offer physical “pre-pay” cards fashioned after traditional credit or debit cards. However, physical pre-pay cards expose users to the inherent risks associated with the physical card being lost, stolen, and/or used for transactions other than what the physical card was intended for. Furthermore, physical cards fashioned after traditional credit or debit cards are resource-intensive and generating and/or replacing such cards may incur large costs to an enterprise and/or the users of the physical cards. Additionally, it is computationally complex to provide a secondary user access to temporary funds associated with a primary user, especially when the secondary user is not related to the primary user (e.g., not a family member) and/or previously associated with an existing payment account of the primary user.

Various enterprises may also offer conventional smart mobile wallets (e.g., digital wallets) that allow a user to access and/or utilize one or more payment methods via a user device (e.g., a smartphone) to execute payment transactions. However, while a smart mobile wallet conveniently allows a user to securely carry multiple forms of payment (e.g., multiple credit cards, bank cards) and may provide a wide range of advantages over traditional payment methods (e.g., physical currency, paper checks), a conventional smart mobile wallet lacks the ability to provide shared access to funds when the smart mobile wallet is tied to a single user device and/or user account. Thus, technical challenges arise for users who wish to temporarily share or loan a form of payment to another user.

Therefore, it may be beneficial to provision a smart mobile wallet with a flexible limit share account (FLSA) that has the flexibility to be shared between a primary user, one or more secondary users, and/or one or more designated users for a temporary duration of time and according to various user-defined guidelines. For example, if a designated user such as a childcare provider, healthcare provider, or contractor is under the employment of a primary user, the primary user may have a need to provide the designated user with access to funds (e.g., for the duration of the designated user’s employment). However, the primary user may not wish to provide the designated user with a physical payment card associated with a payment account (e.g., a credit card, debit card), blank checks, and/or cash, as all of these payment methods are associated with inherent risks (e.g., loss, theft, misuse). Furthermore, the primary user may wish to enforce various rules, restrictions, and/or parameters related to how certain funds are spent by the designated user.

In this regard, embodiments described herein are configured to provide an FLSA to a smart mobile wallet associated with a designated user, where the FLSA may be utilizable only in alignment with various predetermined conditions set forth by the primary user. For example, in some embodiments, an FLSA may be configured (e.g., generated and/or updated) based on a set of FLSA parameters including, but not limited to, one or more of a predetermined balance, a balance limit (e.g., maximum or minimum fund limit), an expiration date, an access time period (e.g., only usable within predefined hours, days, weeks), a recurring monetary deposit (e.g., a recurring monetary deposit to be made from the corresponding existing payment account based on a predetermined schedule), a withdrawal limit (e.g., a $200 withdrawal limit), a transaction geolocation restriction (e.g., only usable within a certain geolocation coordinate perimeter), a merchant restriction (e.g., only usable with approved merchants), FLSA alert parameters (e.g., low balance alerts, transaction occurrence alerts, unauthorized transaction attempt alerts), and/or a designated user visibility restriction (e.g., only certain information related to the FLSA may be viewable by the designated user).

In contrast to conventional techniques for providing temporary access to funds, example embodiments described herein comprise a smart mobile wallet management system configured to provide an FLSA associated with an existing payment account (e.g., credit account, checking account, savings account) of a primary user to one or more designated users. In example embodiments, the smart mobile wallet management system may, at least in part, (i) receive an FLSA generation request from a first user device associated with a primary user, (ii) generate, based on the FLSA generation request, an FLSA associated with an existing payment account of the primary user, (iii) in response to generating the FLSA, receive an FLSA share request associated with the FLSA from the first user device, where the FLSA share request is a request to share access to the FLSA with a designated user, (iv) authenticate, based on the FLSA share request, the primary user and the designated user based on a first mobile driver’s license (mDL) associated with the primary user and a second mDL associated with the designated user, and (v) in response to successfully authenticating the primary user and the designated user, provide the FLSA to a first smart mobile wallet associated with the primary user and a second smart mobile wallet associated with the designated user.

Accordingly, the present disclosure sets forth systems, methods, and apparatuses that provide a user-configurable FLSA for use in executing various transactions (e.g., monetary transactions, mDL-based transactions). There are many advantages of these, and other embodiments described herein. One advantage the smart mobile wallet management system provides is an improvement to the functioning of the computing infrastructure of an enterprise (e.g., a bank or financial institution), such as by reducing the burden on computing resources. For instance, the smart mobile wallet management system described herein reduces the complexity of providing temporary access to funds associated with existing payment accounts for designated users by, among other things, automating processes such as identifying a smart mobile wallet associated with a designated user, authenticating a designated user based on an mDL stored in the smart mobile wallet associated with the designated user, and providing secure access to an FLSA via the smart mobile wallet associated with the designated user.

Another advantage of the smart mobile wallet management system, as described herein, is an improvement to network security technologies and/or authentication technologies by providing increased security for data, payment accounts, and/or valuable resources (e.g., financial resources) related to users and/or enterprises by utilizing mDLs associated with respective users to authenticate the respective users. In this regard, the smart mobile wallet management system may be employed to remotely authenticate a primary user and/or designated user of an FLSA based on a respective mDL associated with the primary user or designated user. As will be described in greater detail below, utilizing mDLs that have been issued by legally entitled entities (e.g., government agencies) adds an additional layer of trust to each transaction facilitated by the smart mobile wallet management system. Furthermore, utilizing mDLs to authenticate and/or verify designated users ensures that only intended parties (e.g., primary users, designated users) are able to access the funds associated with an FLSA.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a smart mobile wallet management system.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example flowchart diagram for providing an FLSA in accordance with some example embodiments described herein.

FIG. 5 illustrates an example flowchart diagram for verifying that a smart mobile wallet is associated with a designated user in accordance with some example embodiments described herein.

FIG. 6 illustrates an example flowchart diagram for authenticating a designated user based on an mDL authentication request in accordance with some example embodiments described herein.

FIG. 7A illustrates an example user interface associated with a smart mobile wallet of a designated user in accordance with some example embodiments described herein.

FIG. 7B illustrates an example user interface associated with a smart mobile wallet of a primary user in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server,” “server device,” or “server system” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

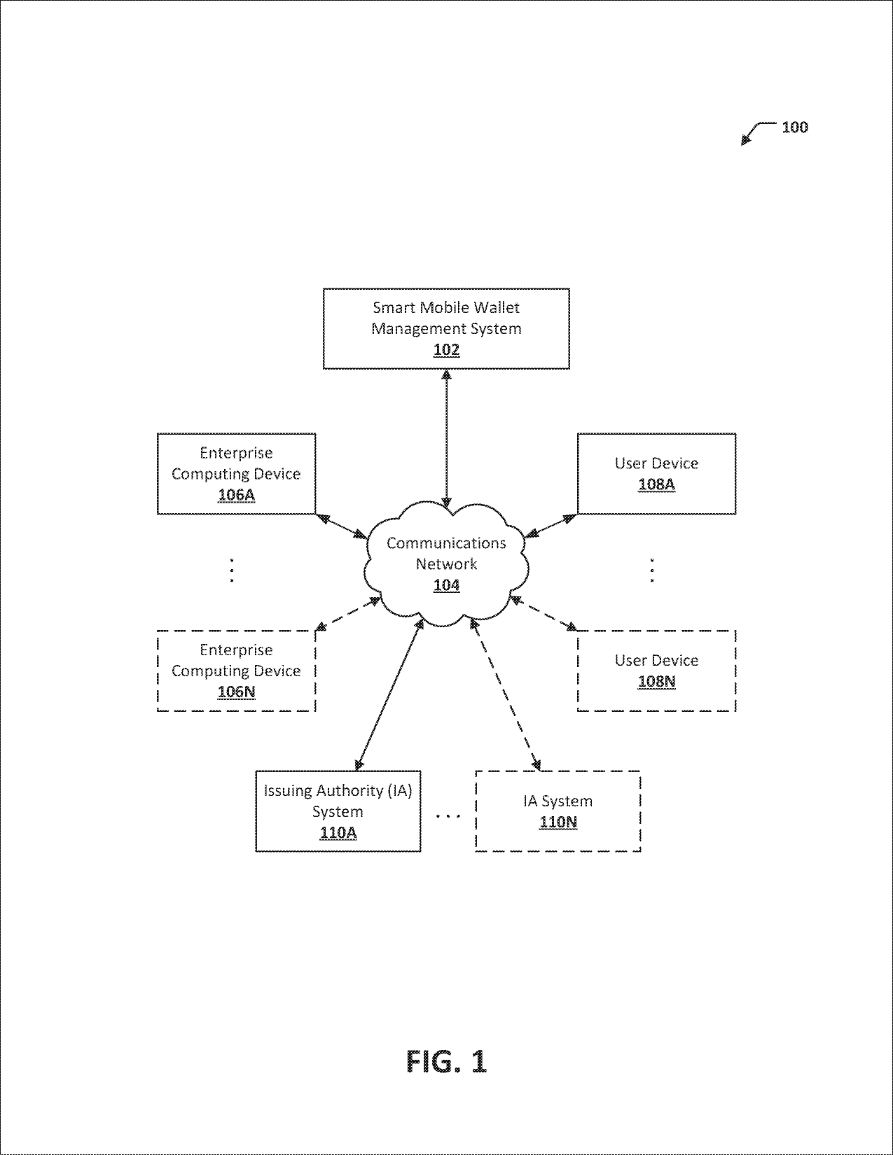

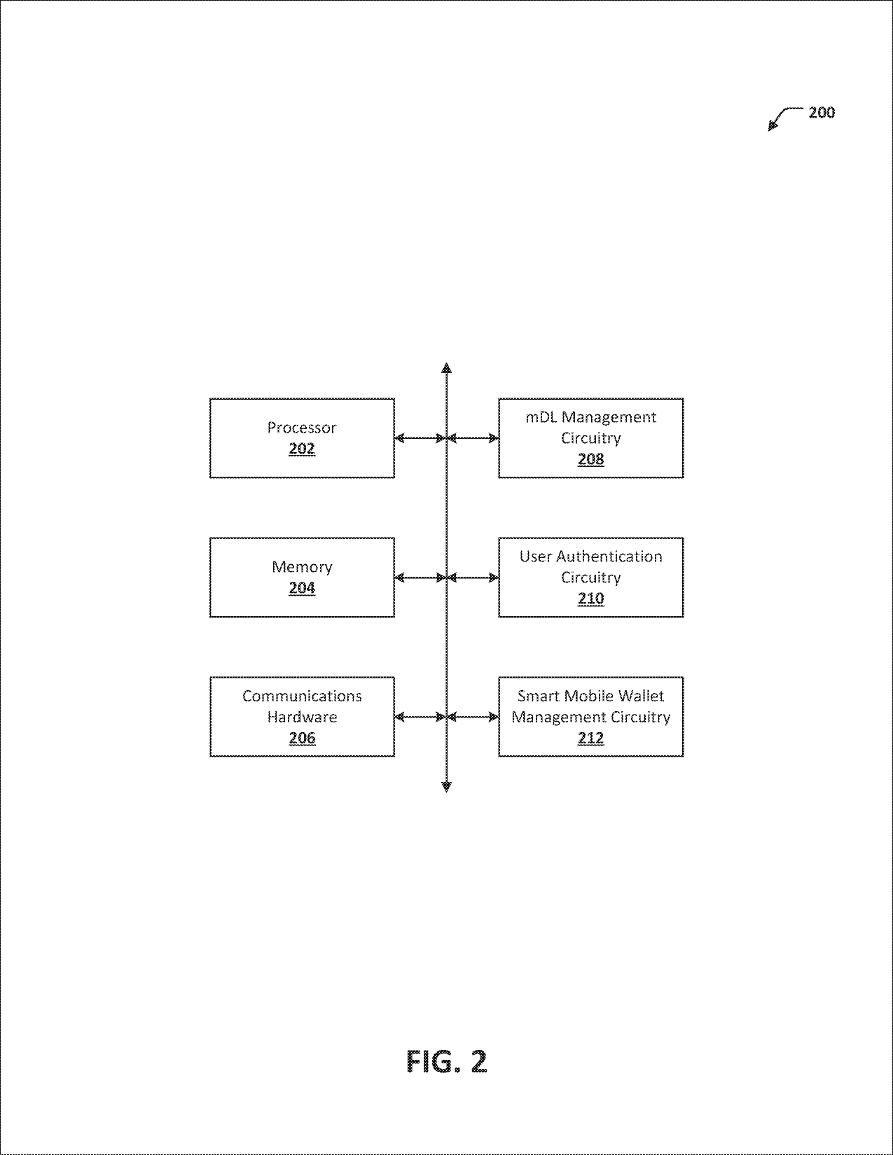

Example embodiments described herein may be implemented using any of a variety of computing devices or servers. To this end, FIG. 1 illustrates an example environment 100 within which various embodiments may operate. As illustrated, a smart mobile wallet management system 102 may receive and/ or transmit information via communications network 104 (e.g., the Internet) with any number of other computing devices and/or computing systems, such as one or more of enterprise computing devices 106A-106N, user devices 108A-108N, and/or issuing authority (IA) systems 110A-110N. The smart mobile wallet management system 102 may be implemented as one or more computing devices or servers, which may be composed of a series of components. Particular components of the smart mobile wallet management system 102 are described in greater detail below with reference to apparatus 200 in connection with FIG. 2.

In various embodiments, the smart mobile wallet management system 102 may be associated with an enterprise (e.g., a financial institution, bank, and/or the like) and may be configured to manage various smart mobile wallet processes for users associated with said enterprise. For example, the smart mobile wallet management system 102 may be configured to manage, execute, initiate, and/or otherwise facilitate one or more smart mobile wallet processes, mDL authentication processes, FLSA generation processes, FLSA sharing processes, FLSA transaction processes, payment account linking processes, payment account transaction processes, user identity verification process, user authentication processes, and/or the like for a plurality of users associated with the respective enterprise.

In this regard, various users associated with an enterprise may interact with the smart mobile wallet management system 102 via a software application instance, where the software application instance may be configured to facilitate one or more of the various smart mobile wallet, mDL authentication processes, and/or FLSA processes described herein. In various embodiments, the software application instance associated with the smart mobile wallet management system 102 may be installed and/or downloaded to a user device (e.g., a user device 108A configured as a mobile device, laptop, and/or the like) and may present one or more user interface configurations to a respective user.

As such, the software application instance associated with the smart mobile wallet management system 102 may be configured to guide a user through the various steps of a FLSA generation and sharing process that may require a user (e.g., a primary user and/or a designated user) to be authenticated based on a corresponding mDL. For example, the software application instance associated with the smart mobile wallet management system 102 may be configured to cause display of various interactive user interface elements to the user that are configured to enable the user to manage one or more portions of smart mobile wallet data (e.g., payment account data, payment card data, FLSA data) and/or user data (e.g., user attribute data, user profile data, user account data, and/or other user data).

In some embodiments, the software application instance may be configured to enable a user to access a smart mobile wallet (e.g., a digital wallet) configured to manage one or more of a user’s mDL, payment accounts (e.g., credit accounts, checking accounts, savings accounts, investment accounts), payment cards (e.g., credit cards, debit cards, and/or the like associated with the user’s payment accounts), and/or FLSAs that are associated with a respective enterprise employing the smart mobile wallet management system 102. Additionally or alternatively, in various embodiments, the software application instance associated with the smart mobile wallet management system 102 may be configured to enable a user to access a software application framework related to a respective enterprise by, for example, providing (e.g., transmitting, enabling, toggling, configuring, etc.) one or more access permissions for a user device (e.g., a user device 108A) associated with the user, where the one or more access permissions enable the user device to access the software application framework associated with the enterprise.

As described herein, the smart mobile wallet management system 102 may be configured to generate an FLSA for a primary user that is to be shared with one or more designated users. An FLSA may be a temporary payment account associated with one or more existing payment accounts of a primary user that can be utilized by the one or more designated users to execute various transactions (e.g., retail purchase transactions). An FLSA may be associated with respective account information such as an account number, routing number, and/or other identifying information. Additionally, an FLSA may be associated with various identifying information associated with the corresponding existing payment account of the primary user, where such identifying information may be used by the smart mobile wallet management system 102 to link the FLSA to the existing payment account of the primary user.

In various embodiments, an FLSA may be stored by and/or linked to one or more smart mobile wallets associated with the primary user and/or the one or more designated users. Furthermore, the FLSA may be associated with one or more digital payment cards (e.g., fashioned after a conventional debit card, credit card, and/or the like) that may be stored by and/or linked to the one or more smart mobile wallets and utilized to execute various transactions via a user device (e.g., user device 108A). In some embodiments, a digital payment card associated with an FLSA may be associated with a respective user (e.g., a primary user or a designated user) and may have a corresponding card number, expiration date, card verification value (CVV), and/or the like. In this regard, the smart mobile wallet management system 102 may be configured to cause an appropriate amount of funds to be withdrawn from the one or more existing payment accounts associated with the FLSA based on any legitimate transaction executed utilizing the FLSA and/or the digital payment card (e.g., by the designated user).

In some embodiments, an FLSA may be utilizable only in alignment with various predetermined conditions set forth by a primary user to whom the FLSA belongs. For example, an FLSA may be configured (e.g., generated and/or updated) based on a set of FLSA parameters including, but not limited to, one or more of a predetermined balance, a balance limit (e.g., maximum or minimum fund limit), an expiration date, an access time period (e.g., only usable within predefined hours, days, weeks), a recurring monetary deposit (e.g., a recurring monetary deposit to be made from the corresponding existing payment account based on a predetermined schedule), a withdrawal limit (e.g., a $200 withdrawal limit), a transaction geolocation restriction (e.g., only usable within a certain geolocation coordinate perimeter), a merchant restriction (e.g., only usable with approved merchants), FLSA alert parameters (e.g., low balance alerts, transaction occurrence alerts, unauthorized transaction attempt alerts), and/or a designated user visibility restriction (e.g., only certain information related to the FLSA may be viewable by the designated user).

In some embodiments, the smart mobile wallet management system 102 may be configured to facilitate the execution of one or more processes related to a FLSA for a respective user based on authenticating an mDL associated with the respective user. As a non-limiting example, the smart mobile wallet management system 102 may be configured to authenticate a designated user based on a respective mDL associated with the designated user before providing an FLSA to a smart mobile wallet associated with the designated user. In this regard, the smart mobile wallet management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. As used herein, the term “mDL” covers various mobile (e.g., digital) identity credential types associated with a respective user including mobile driver’s licenses and mobile identification cards. An mDL may be an electronically managed data structure configured to be accessed, processed, and/or otherwise utilized by the smart mobile wallet management system 102 for various user authentication processes.

In this regard, an mDL may be configured to store or point to (e.g., programmatically reference) various credential data associated with a respective user including, but not limited to, personally identifiable information (PII) (e.g., given name, family name, name prefix, name suffix, driver’s license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver’s license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 110A associated with a particular IA. An IA may be an entity that is legally entitled (or otherwise recognized as the relevant authority) to issue credentials, such as driver’s licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver’s licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver’s License program (EDL)). Additionally or alternatively, in some embodiments, an mDL may be administered, managed, employed, and/or otherwise utilized by the smart mobile wallet management system 102 in compliance with various standards set forth by the American Association of Motor Vehicle Administrators (AAMVA). Additionally or alternatively, in some embodiments, an mDL may be administered, managed, employed, and/or otherwise utilized by the smart mobile wallet management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver’s license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally or alternatively, once an mDL is issued to a user by a respective IA (e.g., by way of a corresponding IA system 110A), the mDL may be stored locally on a user device associated with the user (e.g., user device 108A) such that the mDL may be used without relying on a communications network (e.g., communications network 104). Additionally or alternatively, in some embodiments, an mDL may be stored in a smart mobile wallet associated with the user and managed by the smart mobile wallet management system 102, and the mDL may be accessed and/or utilized by the user via the smart mobile wallet to execute various mDL-based transactions.

In some examples, an IA may provision an mDL to a particular user device (e.g., user device 108A) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., user device 108A) also enables the smart mobile wallet management system 102 and/or an IA system of an IA (e.g., IA system 110A) to verify that the intended user of the mDL is in possession of the mDL. Further still, associating an mDL with a particular user device (e.g., user device 108A) also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user’s personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

Additionally, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., FLSA operations, retail purchase transactions, user authentication protocols, mDL data queries) for a user associated with the mDL. For example, an IA associated with a respective IA system 110A may be associated with a unique public key that may be utilized by the smart mobile wallet management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the smart mobile wallet management system 102 will be described in greater detail herein with reference to FIGS. 2-6.

In some embodiments, the smart mobile wallet management system 102 further comprises and/or integrates with a storage device that comprises a distinct component from other components of the smart mobile wallet management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the smart mobile wallet management system 102. Additionally or alternatively, the storage device may store information relied upon during operation of the smart mobile wallet management system 102, such as various user data (e.g., user attribute data, user identification data), mDL data (e.g., cryptographic information, credential information), enterprise data (e.g., payment account data, user transaction data, product and/or service data), smart mobile wallet data (e.g., payment account data, payment card data, FLSA data, and/or the like associated with a user), distribution data, logistical data, legal data, software application framework data, etc.), and/or the like configured in various data formats to be utilized by the smart mobile wallet management system 102. In addition, the storage device may store control signals, device characteristics, and/or access credentials enabling interaction between the smart mobile wallet management system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

The smart mobile wallet management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-6. As illustrated in FIG. 2, the apparatus 200 may include processor 202, memory 204, communications hardware 206, mDL management circuitry 208, user authentication circuitry 210, and/or smart mobile wallet management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

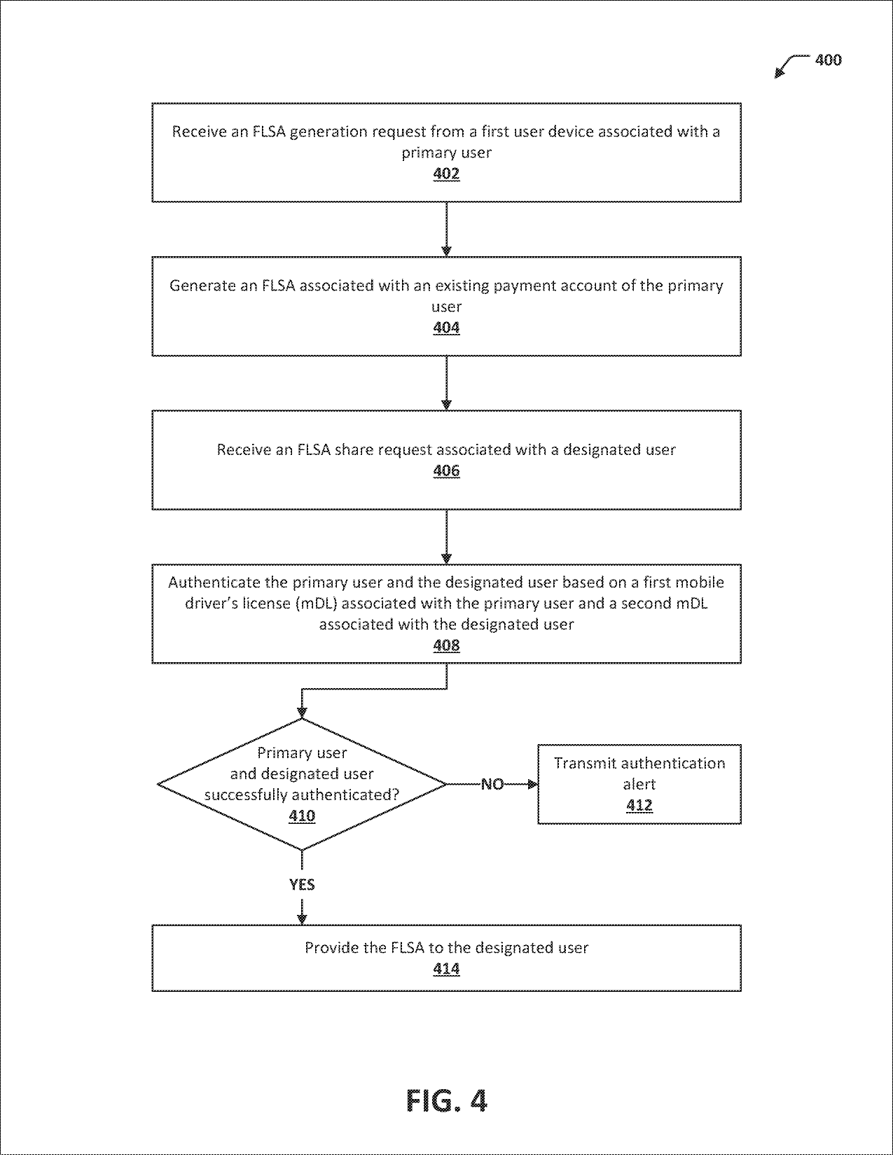

In addition, the apparatus 200 further comprises mDL management circuitry 208. In some embodiments, the mDL management circuitry 208 may be configured to facilitate the execution of one or more mDL authentication and/or IA authentication operations for an enterprise associated with the smart mobile wallet management system 102. Additionally, the mDL management circuitry 208 may utilize processor 202, memory 204, or any other hardware component included in the apparatus 200 to perform these operations, as described in connection with FIGS. 4-6 below. The mDL management circuitry 208 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the mDL management circuitry 208 may work in conjunction with the user authentication circuitry 210 and/or the smart mobile wallet management circuitry 212 in order to execute one or more of the methods described herein. For example, in some embodiments, the mDL management circuitry 208 may integrate with and/or otherwise leverage the user authentication circuitry 210 to facilitate the authentication of a primary user and/or a designated user based on a respective mDL associated with the primary user and/or the designated user.

In various circumstances, an IA system (e.g., IA system 110A) that previously issued an mDL to a respective user may periodically update credential data associated with the mDL (e.g., new user contact information, updated credential restrictions, updated credential endorsements). As such, the mDL management circuitry 208 may be configured to retrieve and/or receive updated credential data associated with a user’s mDL from an IA system (e.g., IA system 110A) and facilitate the updating of the user’s mDL based on the updated credential data. For example, if an mDL associated with a user is stored in a smart mobile wallet being managed by the smart mobile wallet management system 102, the mDL management circuitry 208 may be configured to receive updated credential data associated with the user’s mDL from the originating IA system (e.g., IA system 110A) and subsequently update the user’s mDL in the smart mobile wallet based on the updated credential data.

In some embodiments, the mDL management circuitry 208 may work in conjunction with the smart mobile wallet management circuitry 212 in order to update an mDL stored in a smart mobile wallet stored on a user device (e.g., user device 108A). In such embodiments, the mDL management circuitry 208 may be configured to query one or more storage devices (e.g., server systems) associated with an IA system (e.g., IA system 110A) in order to retrieve current and/or updated credential data in response to one or more interactions with a user interface associated with the smart mobile wallet. Additionally or alternatively, the mDL management circuitry 208 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user’ mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 208 may utilize the technical validity period indicated by the MSO to ensure that the credential data associated with the mDL stored on a user device (e.g., user device 108A) is updated and/or current. For example, if the mDL management circuitry 208 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver’s license associated with the mDL).

For example, legal credentials (e.g., a driver’s license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user’s legal credential, yet the user fails to have the legal credential (e.g., a corresponding physical credential) updated with said credential restrictions and/or credential endorsements. To address such problems, if the mDL management circuitry 208 determines that the technical validity period indicated by the MSO of the mDL has expired, the corresponding mDL may flag the mDL such that the mDL will fail various authentication protocols during an mDL-based transaction.

In this regard, the mDL management circuitry 208 may be configured to facilitate the resetting of the technical validity period indicated by the MSO of the mDL in conjunction with a corresponding IA system (e.g., IA system 110A). Additionally or alternatively, the mDL management circuitry 208 may be configured to facilitate the updating and/or verification of the credential data associated with an mDL stored on a user device (e.g., user device 108A) each time the technical validity period associated with the MSO of the mDL is reset. This mDL data security mechanism ensures that the credential data associated with a user’s mDL is always accurate and up to date.

As described herein, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., FLSA operations, retail purchase transactions, user authentication protocols, mDL data queries) for a user associated with the mDL. In this regard, the mDL management circuitry 208 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the mDL management circuitry 208 may be configured to first obtain a public key associated with the IA from a corresponding IA system 110A based on the identifying information. Once the public key information associated with the IA is obtained, the mDL management circuitry 208 may be configured to generate an IA authentication request comprising the public key of the IA and transmit the IA authentication request to the IA system 110A (e.g., via the communications network 104). As such, the mDL management circuitry 208 may be configured to receive, from an IA system (e.g., IA system 110A) and in response to the IA authentication request, one or more portions of data indicating whether the IA is a bona fide IA and/or whether the mDL indeed originated from the IA.

Once the mDL management circuitry 208 confirms the validity of the IA and/or confirms that a particular mDL associated with a user originated from the IA, the mDL management circuitry 208 may be configured to generate a digital token comprising cryptographic information (e.g., public key information) associated with the mDL and the user. Additionally, in some embodiments, the cryptographic information associated with the mDL and comprised in the digital token may be user device identification data by which a user device (e.g., user device 108A) of the respective user may be uniquely identified. In various examples, the mDL management circuitry 208 may generate and/or transmit the digital token to an IA system (e.g., IA system 110A) such that the IA system may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A). In this regard, the mDL management circuitry 208 may be configured to receive, from the IA system (e.g., IA system 110A) and in response to transmitting the digital token, one or more portions of data indicating whether the mDL and/or the user device (e.g., user device 108A) identified by the digital token is valid. Furthermore, in various examples, the mDL management circuitry 208 may be configured to receive, from the IA system (e.g., IA system 110A) and in response to transmitting the digital token, one or more portions of credential data associated with the mDL.

In some embodiments, the mDL management circuitry 208 may be configured to generate a digital token comprising cryptographic information (e.g., public key information) associated with an mDL and/or a user device (e.g., user device 108A) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographic information (e.g., public key information) associated with an mDL and/or a user device (e.g., user device 108A). Additionally or alternatively, a respective mDL authentication request may comprise one or more desired data elements (e.g., one or more desired portions of credential data) associated with the mDL, location data, user profile data, user account data, social media data, smart mobile wallet identification data, user device identification data, and/or the like associated with the particular user. In various examples, the mDL authentication request may be associated with one or more of a primary user, a secondary user associated with an existing payment account of the primary user, and/or a designated user, and may be comprised in, or triggered by, an FLSA share request received by the smart mobile wallet management system 102.

In various examples, an mDL validity response received from an IA system (e.g., IA system 110A) based on a digital token generated by the mDL management circuitry 208 may comprise the entirety of the credential data associated with the mDL of the particular user. Additionally or alternatively, in various other examples, an mDL validity response received from an IA system (e.g., IA system 110A) based on a digital token generated by the mDL management circuitry 208 may comprise a verification of the desired credential data associated with the mDL that was indicated by an mDL authentication request. Additionally or alternatively, in various other examples, an mDL validity response received from an IA system (e.g., IA system 110A) based on a digital token generated by the mDL management circuitry 208 may comprise a verification of the user device identification data associated with the user device (e.g., user device 108A) of the particular user. For example, the mDL validity response may verify that the user device currently associated with the mDL is the same (e.g., intended) user device that the mDL was originally provisioned to. In this manner, the smart mobile wallet management system 102 may be configured to confirm the validity of the mDL data of an mDL associated with a particular user in order to authenticate the identity of the particular user. Additionally, this enables the smart mobile wallet management system 102 to confirm whether the intended user and/or user device (e.g., user device 108A) associated with the mDL is currently in possession of the mDL. These and other operations associated with the mDL management circuitry 208 will be described in further detail herein below with reference to FIGS. 4-6.

In addition, the apparatus 200 further comprises user authentication circuitry 210. In some embodiments, the user authentication circuitry 210 may be configured to facilitate the execution of one or more user authentication operations for an enterprise associated with the smart mobile wallet management system 102. Additionally, the user authentication circuitry 210 may utilize processor 202, memory 204, to perform these operations, as described in connection with FIGS. 4-6 below. The user authentication circuitry 210 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the user authentication circuitry 210 may work in conjunction with the mDL management circuitry 208 and/or the smart mobile wallet management circuitry 212 in order to execute one or more of the methods described herein. For example, in some embodiments, the user authentication circuitry 210 may integrate with and/or otherwise leverage the mDL management circuitry 208 to facilitate the identification and/or authentication of a primary user and/or a designated user based on a respective mDL associated with the primary user and/or the designated user.

Additionally, the user authentication circuitry 210 may be configured to identify a smart mobile wallet associated with a respective user (e.g., a primary user, a designated user, and/or the like). For example, the user authentication circuitry 210 may identify a smart mobile wallet associated with a designated user based on attribute data associated with the designated user. In such examples, the user attribute data associated with the designated user may be comprised in an FLSA share request received by the smart mobile wallet management system 102 from a user device (e.g., user device 108A) of a primary user. As described herein, an FLSA share request may be a request to share access to a respective FLSA with a designated user via a smart mobile wallet associated with the designated user. In some embodiments, user attribute data associated with a respective user (e.g., a primary user, a designated user, and/or the like) may comprise user profile data, user account data, user contact data, social media data, location data, and/or smart mobile wallet identification data associated with the respective user.

In various examples, once the user authentication circuitry 210 identifies a smart mobile wallet that is ostensibly associated with the respective user, the user authentication circuitry 210 may be configured to generate a user identification data request based on user attribute data associated with the respective user (e.g., the primary user, the designated user, and/or the like). The user authentication circuitry 210 may be configured to leverage the communications hardware 206 to transmit the user identification data request to the smart mobile wallet ostensibly associated with the respective user. Furthermore, the user authentication circuitry 210 may be configured to leverage the communications hardware 206 to receive user identification data from the smart mobile wallet ostensibly associated with the respective user based on the user identification data request.

In various examples, the user identification data associated with a respective user (e.g., the primary user, the designated user, and/or the like) comprises cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user. In this regard, the user authentication circuitry 210 may be configured to verify that the smart wallet ostensibly associated with the respective user (e.g., the primary user, the designated user, and/or the like) is indeed associated with the respective user and that the smart mobile wallet management circuitry 212 may safely transmit and/or receive data (e.g., FLSA data, payment account data, transaction data) to and/or from the smart mobile wallet associated with the respective user.

Additionally or alternatively, in some embodiments, the user authentication circuitry 210 may be configured to facilitate execution of secondary user authentication of a respective user in addition to authenticating the respective user based on a corresponding mDL. In this regard, the user authentication circuitry 210 may be configured to facilitate the execution of a second factor of authentication including one or more of facial recognition, voice recognition, and/or biometric authentication techniques (e.g., fingerprint recognition, retina recognition, iris recognition). For example, the user authentication circuitry 210 may be configured to prompt a respective user via a user device (e.g., user device 108A) to authenticate themselves via a second factor of authentication (e.g., biometric authentication based on fingerprint data) before allowing the respective user to access a smart mobile wallet managed by the smart mobile wallet management system 102. Additionally or alternatively, in various embodiments, the user authentication circuitry 210 may be configured to prompt a respective user via a user device (e.g., user device 108A) to authenticate themselves via a second factor of authentication (e.g., voice recognition) either prior to or subsequent to authenticating the respective user based on an mDL associated with the respective user.

Additionally or alternatively, in some embodiments, the user authentication circuitry 210 may be configured to employ one or more facial recognition techniques to authenticate a user during a secondary user authentication process. For example, user authentication circuitry 210 may be configured to authenticate a respective user by matching image data related to the respective user’s face that is captured in real time, or near-real time, (e.g., via a camera of a user device 108A) to user portrait image data associated with an mDL related to the respective user. In this regard, the user authentication circuitry 210 may be configured to generate an image matching score based on matching the image data of the user’s face captured in real time, or near-real time, to the user portrait image data associated with the user’s mDL.

As such, the user authentication circuitry 210 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of ±1%, ±5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of ±1%, ±5%, or any other number). In this manner, the user authentication circuitry 210 may facilitate secondary authentication techniques in order to authenticate a respective user before allowing the respective user to access a respective smart mobile wallet via a user device (e.g., user device 108A). These and other operations associated with the user authentication circuitry 210 will be described in further detail herein below with reference to FIGS. 4-6.

In addition, the apparatus 200 further comprises smart mobile wallet management circuitry 212. In some embodiments, the smart mobile wallet management circuitry 212 may be configured to facilitate the execution of one or more smart mobile wallet operations and/or transactions for an enterprise associated with the smart mobile wallet management system 102. Additionally, the smart mobile wallet management circuitry 212 may utilize processor 202, memory 204, to perform these operations, as described in connection with FIGS. 4-6 below. The smart mobile wallet management circuitry 212 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the smart mobile wallet management circuitry 212 may work in conjunction with the mDL management circuitry 208 and/or the user authentication circuitry 210 in order to execute one or more of the methods described herein.

For example, in some embodiments, the smart mobile wallet management circuitry 212 may integrate with and/or otherwise leverage the user authentication circuitry210 to facilitate the identification and/or authentication of a primary user and/or a designated user in order to generate and/or provide an FLSA to a respective smart mobile wallet associated with the primary user and/or the designated user. In various embodiments, the smart mobile wallet management circuitry 212 may be configured to generate an FLSA in response to an FLSA generation request received from a user device (e.g., user device 108A) associated with a primary user. In some embodiments, the FLSA generation request may be generated and/or received from the user device (e.g., user device 108A) based on a user interaction with a user interface corresponding to a smart mobile wallet being managed by the smart mobile wallet management system 102. Furthermore, the FLSA generation request may comprise one or more FLSA parameters configured (e.g., indicated, selected, and/or the like) via the interaction with the user interface corresponding to the smart mobile wallet.

In this regard, the smart mobile wallet management circuitry 212 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally or alternatively, the smart mobile wallet management circuitry 212 may be configured to leverage the processor 202, the memory 204, and/or the communications hardware 206 to generate and/or conFIGURE(e.g., instantiate, update) a smart mobile wallet comprising one or more of a plurality of interactive user interface elements. The smart mobile wallet management circuitry 212 may generate a smart mobile wallet for a respective user (e.g., a primary user, a designated user, and/or the like) based on one or more user attributes associated with the respective user and/or enterprise data corresponding to the respective user stored by the enterprise associated with the smart mobile wallet management system 102. Additionally, the smart mobile wallet management circuitry 212 may be configured to leverage the processor 202, the memory 204, and/or the communications hardware 206 to provide the smart mobile wallet to a user device (e.g., user device 108A) associated with the respective user such that the respective user is enabled to interact with and/or utilize the smart mobile wallet to execute various operations, transactions, and/or the like.

For example, based on one or more interactions with a respective smart mobile wallet, the smart mobile wallet management circuitry 212 may be configured to generate and/or configure an FLSA associated with an existing payment account of a respective user (e.g., an existing bank account managed by a financial institute with which the primary user is a member). Additionally or alternatively, the smart mobile wallet management circuitry 212 may be configured to display various digital representations and/or data related to an FLSA, an existing payment account, a digital payment card, a physical payment card, and/or the like via a smart mobile wallet associated with the respective user. Additionally or alternatively, the smart mobile wallet management circuitry 212 may be configured to facilitate the configuration, reconfiguration, update and/or management of an FLSA, an existing payment account, a digital payment card, a physical payment card, and/or the like via a smart mobile wallet associated with the respective user.

Additionally, based on one or more interactions with a respective smart mobile wallet, the smart mobile wallet management circuitry 212 may be configured to facilitate one or more financial transactions for a respective user (e.g., a primary user, designated user, and/or the like). The one or more financial transactions may involve the settlement of a payment (e.g., the withdrawal and transfer of funds) initiated by a respective user with a particular merchant (e.g., an online merchant, a brick-and-mortar retailer). In this regard, the smart mobile wallet management circuitry 212 may be configured to utilize account data (e.g., user account identifier information, user account routing information, and/or the like) associated with one or more means of payment (e.g., an FLSA, a payment card) stored in and/or associated with a smart mobile wallet of a respective user to ensure an appropriate amount of funds is transferred from the respective user to the merchant. These and other operations associated with the smart mobile wallet management circuitry 212 will be described in further detail herein below with reference to FIGS. 4-6.

Although components 202-212 are described in part using functional language, it will be understood that the particular implementations necessarily include the use of particular hardware. It should also be understood that certain of these components 202-212 may include similar or common hardware. For example, the mDL management circuitry 208, the user authentication circuitry 210, and/or the smart mobile wallet management circuitry 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the mDL management circuitry 208, the user authentication circuitry 210, and/or the smart mobile wallet management circuitry 212 may leverage processor 202, memory 204, and/or communications hardware 206 as described above, it will be understood that any of the mDL management circuitry 208, the user authentication circuitry 210, and/or the smart mobile wallet management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the mDL management circuitry 208, the user authentication circuitry 210, and/or the smart mobile wallet management circuitry 212 comprise particular machinery designed for performing the functions described herein in connection with such elements of apparatus 200.

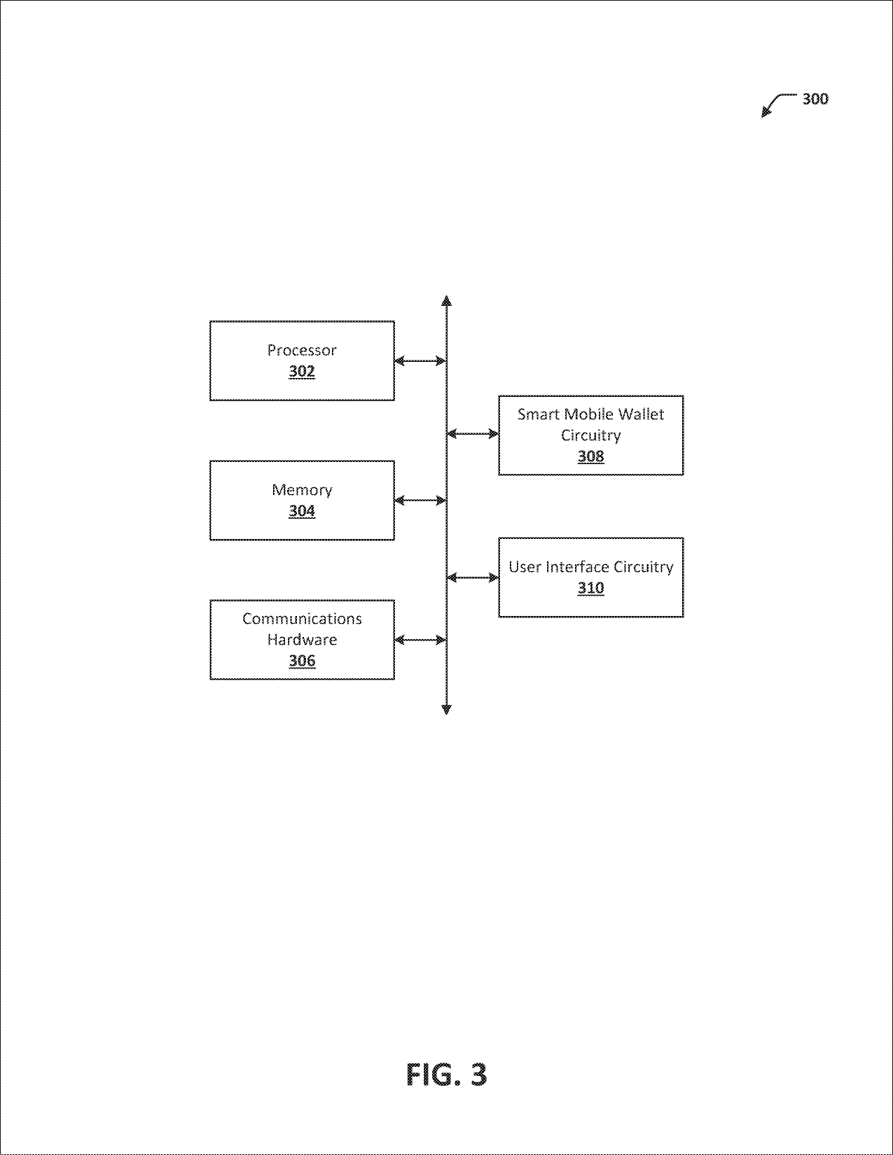

As illustrated in FIG. 3, an apparatus 300 is shown that represents an example enterprise computing device (e.g., any of enterprise computing devices 106A-106N) or an example user device (e.g., any of user devices 108A-108N). The apparatus 300 includes processor 302, memory 304, and communications hardware 306, each of which is configured to be similar to the similarly named components described above in connection with FIG. 2. Additionally, the apparatus 300 may also include smart mobile wallet circuitry 308, and/or user interface circuitry 310, each of which may be configured to facilitate the execution of the various methods described herein. For example, the smart mobile wallet circuitry 308, and/or the user interface circuitry 310 may be configured to work in conjunction to facilitate user interaction with the smart mobile wallet management system 102. Furthermore, the smart mobile wallet circuitry 308 may be configured to manage and/or facilitate one or more actions related to a smart mobile wallet associated with a respective user (e.g., a primary user, designated user, and/or the like) on a user device (e.g., user device 108A) that has been provisioned by the smart mobile wallet management system 102. In some embodiments, the smart mobile wallet circuitry 308 may utilize processor 302, memory 304, or any other hardware component included in the apparatus 300 to perform one or more of the operations described in connection with FIGS. 4-6 below.

In some embodiments, the smart mobile wallet circuitry 308 includes hardware components designed for generating one or more requests configured to initiate various operations to be executed by the smart mobile wallet management system 102. For example, the smart mobile wallet circuitry 308 may be configured to generate an FLSA generation request for a primary user based on one or more interactions (e.g., user input, user selection) with a smart mobile wallet on a user device (e.g., user device 108A). As described herein, the FLSA generation request may comprise a set of FLSA parameters indicated by the primary user that define how an FLSA is to be configured and/or utilized by one or more designated users. In some embodiments, the FLSA parameters associated with the FLSA generation request may be entered, selected, and/or otherwise indicated in whole or in part by the primary user (e.g., via a user interface associated with a smart mobile wallet). Additionally or alternatively, the FLSA parameters associated with the FLSA generation request may be automatically populated in whole or in part by the smart mobile wallet circuitry 308.

Additionally or alternatively, in some embodiments, the smart mobile wallet circuitry 308 may be configured to generate and/or cause transmission of an FLSA share request that indicates one or more designated users with which the primary user wishes to share access to an FLSA. In some embodiments, an FLSA share request comprises one or more portions of user attribute data associated with one or more respective users (e.g., the primary user, one or more designated user, and/or the like). Furthermore, in some embodiments, the user attributes associated with the FLSA share request may be entered, selected, and/or otherwise indicated in whole or in part by the primary user (e.g., via a user interface associated with a smart mobile wallet). Additionally or alternatively, the user attributes associated with the FLSA share request may be automatically populated in whole or in part by the smart mobile wallet circuitry 308. In various embodiments, an FLSA share request may be configured to comprise and/or trigger the transmission and/or execution of one or more mDL authentication requests associated with one or more respective users (e.g., a primary user, one or more designated users, and/or the like) associated with the FLSA share request. The one or more mDL authentication requests may be requests to verify and/or authenticate one or more respective users based on a corresponding mDL.

In various embodiments, the smart mobile wallet circuitry 308 may be configured to generate responses to various queries transmitted to a smart mobile wallet on a respective user device (e.g., user device 108A). For example, as described herein, the smart mobile wallet management system 102 may be configured to generate and/or transmit user identification data requests (e.g., primary user identification data requests, designated user identification data requests, and/or the like) to respective smart mobile wallets to facilitate the one or more operations described herein. As such, the smart mobile wallet circuitry 308 may be configured to generate and/or cause transmission of a response providing user identification data comprised in and/or associated with a smart mobile wallet on the user device (e.g., user device 108A).

As described herein, the user identification data associated with a respective user (e.g., the primary user, the designated user, and/or the like) may comprise cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user.

Additionally, the smart mobile wallet circuitry 308 may be configured to facilitate various actions associated with one or more payment methods associated with a smart mobile wallet on a respective user device (e.g., user device 108A). For example, the smart mobile wallet circuitry 308 may be configured to facilitate the management of, utilization of, and/or interaction with one or more of a payment card (e.g., a credit card, debit card), payment account (e.g., FLSA, checking account, saving account), and/or user account affiliated with an enterprise (e.g., financial institution) associated with the smart mobile wallet management system 102. For instance, in some embodiments, the smart mobile wallet circuitry 308 may be configured to enable a user to check an account balance, view historical transactions, initiate a payment transaction, stop a payment transaction, transfer funds, link a payment account or method, unlink a payment account or method, settle a payment transaction at a point of sale (POS) associated with a merchant, settle an online payment transaction, and/or the like via the smart mobile wallet on a respective user device (e.g., user device 108A).

Furthermore, the smart mobile wallet circuitry 308 may be configured to facilitate various actions associated with an mDL of a respective user that is stored in and/or associated with the smart mobile wallet on a respective user device (e.g., user device 108A). For example, the smart mobile wallet circuitry 308 may be configured to cause an mDL to be updated, verified, authenticated and/or deleted from the smart mobile wallet. In some embodiments, the smart mobile wallet circuitry 308 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally or alternatively, the smart mobile wallet circuitry 308 may be configured to leverage the communications hardware 306 to cause one or more components of the apparatus 200 (e.g., the mDL management circuitry 208) to facilitate the update of an mDL stored in a smart mobile wallet of a respective user device (e.g., user device 108A).

In addition, the apparatus 300 may also include the user interface circuitry 310, which includes hardware components designed for receiving user inputs and/or rendering virtual graphics outputs. The user interface circuitry 310 may utilize processor 302, memory 304, or any other hardware component included in, or integrated with, the apparatus 300 to perform these operations, as described in connection with FIGS. 4-6 below. The user interface circuitry 310 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 310 may comprise one or more of a keyboard, pointing device, touchscreen, microphone with speech recognition interface, one or more cameras, and/or one or more other input devices capable of receiving various different user inputs. In addition, the user interface circuitry 310 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 310 may utilize processor 302, memory 304, smart mobile wallet circuitry 308, or any other hardware component included in, or integrated with, the apparatus 300 to run, host, configure, and/or otherwise execute one or more operations, instructions, and/or commands related to a software application instance and/or smart mobile wallet associated with the smart mobile wallet management system 102. For example, the user interface circuitry 310 may be configured allow a user to interact with the smart mobile wallet management system 102 via the software application instance in order to facilitate one or more FLSA operations, smart mobile wallet operations, user authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-6, example flowcharts are illustrated that contain example operations implemented by example embodiments described herein. The operations illustrated in FIGS. 4-6 may, for example, be performed by a system device (e.g., server, etc.) of the smart mobile wallet management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mDL management circuitry 208, user authentication circuitry 210, smart mobile wallet management circuitry 212, and/or any combination thereof. It will be understood that user interaction with the smart mobile wallet management system 102 may occur directly via communications hardware 206, or may instead be facilitated by a separate computing device (e.g., any of enterprise computing devices 106A-106N, and/or user devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, flowchart 400 illustrates example operations for providing an FLSA to one or more smart mobile wallets associated with one or more respective users.

As shown by operation 402, the apparatus 200 may include means, such as processor 202, memory 204, communications hardware 206, and/or the like for receiving an FLSA generation request from a first user device (e.g., user device 108A) associated with a primary user. As described herein, the FLSA generation request may comprise a set of FLSA parameters indicated by the primary user that define how an FLSA is to be configured and/or utilized by one or more designated users. In some embodiments, the FLSA parameters associated with the FLSA generation request may be entered, selected, and/or otherwise indicated in whole or in part by the primary user via a user interface associated with a smart mobile wallet managed by the smart mobile wallet management system 102. In some embodiments, in order to access a user interface to provide an FLSA generation request, the primary user may be required to provide associated user credentials (e.g., password, personal identification number, biometric data, etc.) to login to an associated user account. In an instance in which the primary user is successfully authenticated using the provided user credentials, the primary user may then be allowed to proceed with the FLSA generation request.

The set of FLSA parameters may comprise one or more of a predetermined balance, a balance limit (e.g., maximum or minimum fund limit), an expiration date, an access time period (e.g., only usable within predefined hours, days, weeks), a recurring monetary deposit (e.g., a recurring monetary deposit to be made from the corresponding existing payment account based on a predetermined schedule), a withdrawal limit (e.g., a $200 withdrawal limit), a transaction geolocation restriction (e.g., only usable within a certain geolocation coordinate perimeter), a merchant restriction (e.g., only usable with approved merchants), FLSA alert parameters (e.g., low balance alerts, transaction occurrence alerts, unauthorized transaction attempt alerts), and/or a designated user visibility restriction (e.g., only certain information related to the FLSA may be viewable by the designated user).

As shown by operation 404, the apparatus 200 may include means, such as processor 202, memory 204, communications hardware 206, smart mobile wallet management circuitry 212, and/or the like for generating an FLSA associated with an existing payment account of the primary user. In some embodiments, the smart mobile wallet management circuitry 212 may be configured to generate an FLSA associated with an existing payment account (e.g., an existing checking account) owned by the primary user in response to an FLSA generation request received from the first user device (e.g., user device 108A) associated with the primary user. Additionally, as described herein, the smart mobile wallet management circuitry 212 may generate the FLSA based on a set of FLSA parameters indicated by the FLSA generation request. In some embodiments, the smart mobile wallet management circuitry 212 may be configured with default and/or static values for one or more FLSA parameters. As such, the smart mobile wallet management circuitry 212 may use these values in an instance in which a primary user does not provide a value for an FLSA parameter or if the FLSA parameter value cannot be selected by the primary user, such as for security reasons. Thus, the smart mobile wallet management circuitry 212 may generate a FLSA that is compliant with one more governmental and/or institutional policies and/or regulations.

In various examples, the FLSA may be configured to be linked to and/or utilized via a first smart mobile wallet on a first user device (e.g., user device 108A) associated with the primary user, a second smart mobile wallet on a second user device (e.g., user device 108B) associated with a designated user, a third smart mobile wallet on a third user device (e.g., user device 108C) associated with a secondary user that is a co-owner of the existing payment account of the primary user (e.g., a spouse, significant other, or the like of the primary user), and/or the like. In examples in which the existing payment account of the primary user is an existing joint payment account associated with the secondary user (e.g., a spouse, significant other), the smart mobile wallet management circuitry 212 may be configured to query the third user device (e.g., user device 108C) associated with the secondary user for permission to generate an FLSA associated with the existing joint payment account. In this regard, the smart mobile wallet management circuitry 212 may be configured to generate an FLSA generation permission request, where the FLSA generation permission request is a request to authorize generation of the FLSA associated with the existing joint payment account.

The smart mobile wallet management circuitry 212 may be configured to leverage the communications hardware 206 to provide the FLSA generation permission request to the third user device (e.g., user device 108C) associated with the secondary user. Furthermore, based on receiving (e.g., by the communications hardware 206), an affirmative FLSA generation permission request response from the third user device (e.g., user device 108C), the smart mobile wallet management circuitry 212 may proceed to generate the FLSA associated with the existing payment account.

As shown by operation 406, the apparatus 200 may include means, such as processor 202, memory 204, communications hardware 206, and/or the like for receiving an FLSA share request associated with the FLSA from the first user device (e.g., user device 108A). The FLSA share request may be a request to share access to the FLSA with the designated user via the second mobile wallet on the second user device (e.g., user device 108B) of the designated user. Furthermore, the FLSA share request may be received in response to an acknowledgement of the successful generation of the FLSA. As a non-limiting example, a primary user may have contracted a private childcare provider to care for one or more of the primary user’s children. As such, the primary user may have a need to grant the childcare provider temporary access to funds in case the childcare provider needs to make a purchase for the children (e.g., emergencies, groceries, clothes, entertainment). In this example, the corresponding FLSA share request may comprise one or more portions of user attribute data associated with the designated user (e.g., the childcare provider) such as user profile data, user account data, user contact data, social media data, location data, and/or smart mobile wallet identification data associated with the designated user.

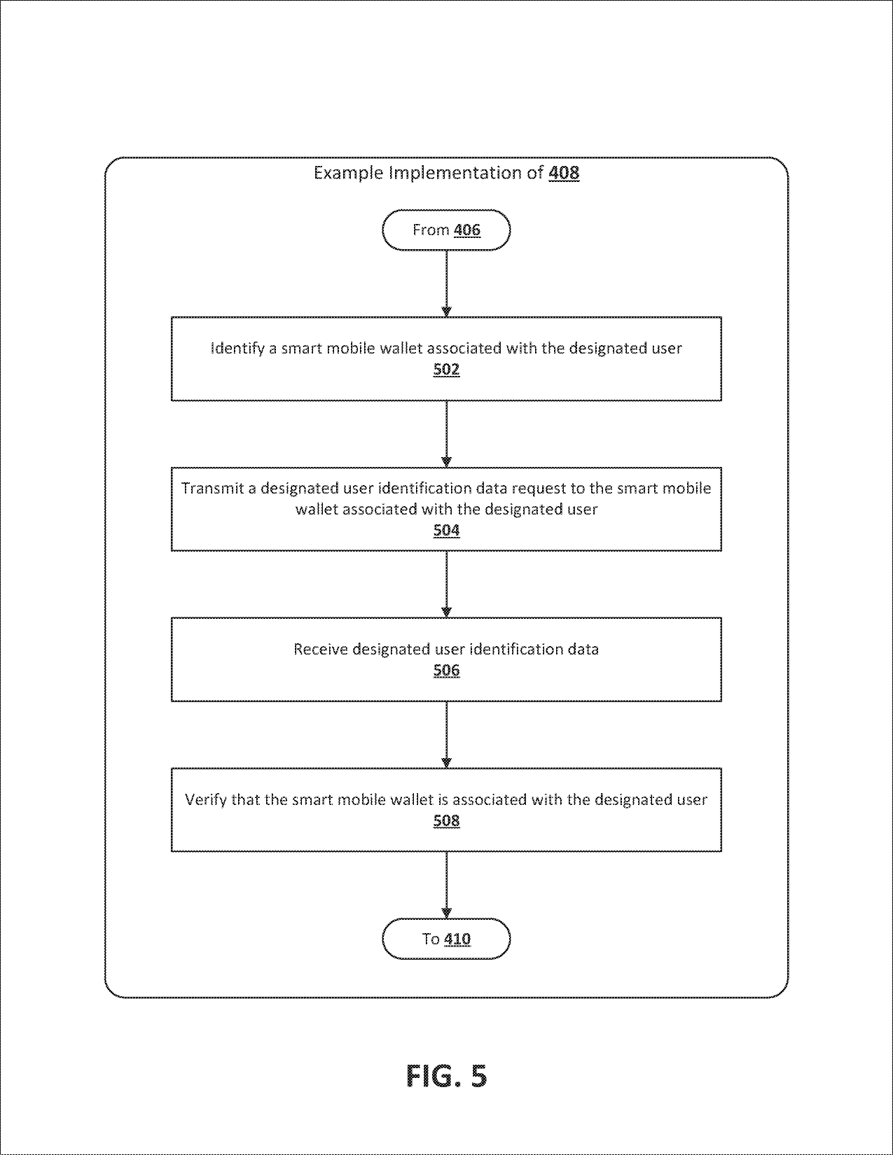

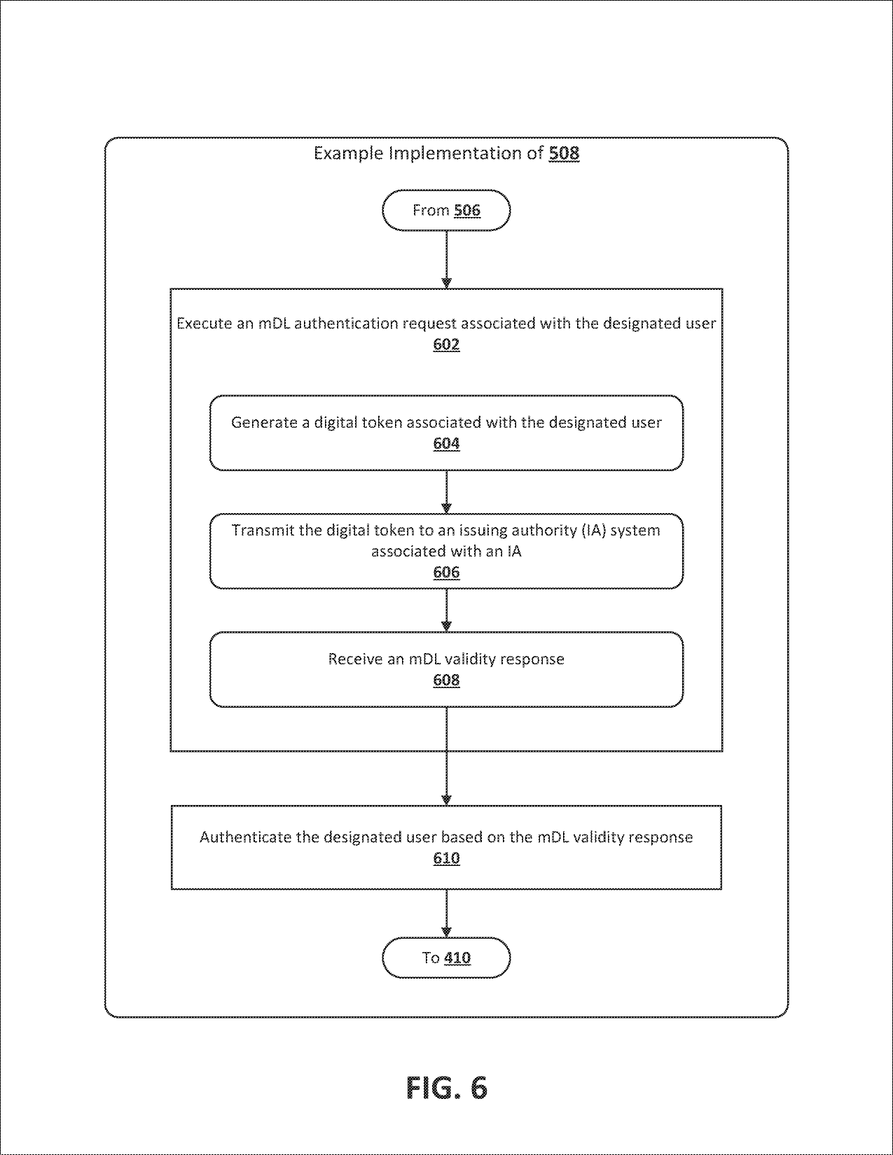

As shown by operation 408, the apparatus 200 may include means, such as processor 202, memory 204, communications hardware 206, mDL management circuitry 208, user authentication circuitry 210, smart mobile wallet management circuitry 212, and/or the like for authenticating the primary user and the designated user based on a first mDL associated with the primary user and a second mDL associated with the designated user. In some embodiments, the user authentication circuitry 210 may leverage one or more of the communications hardware 206, the mDL management circuitry 208, and/or the smart mobile wallet management circuitry 212 to authenticate the primary user and/or the designated user in response to receiving the FLSA share request from the first user device (e.g., user device 108A) associated with the primary user. Further details related to example implementations of operation 408 will be described herein with reference to FIG. 5 and FIG. 6.

Turning now to FIG. 5, example operations are shown for verifying that a smart mobile wallet (e.g., the second smart mobile wallet) is associated with a designated user. As described herein, FIG. 5 illustrates some example implementations of operation 408 described herein with reference to FIG. 4. In some embodiments, the operations of FIG. 5 may be performed in response to the successful authentication of a primary user. For example, in some embodiments, once the primary user has been authenticated based on the first mDL comprised in the first mobile smart wallet associated the primary user, the user authentication circuitry 210 may be configured to facilitate (e.g., initiate, execute, manage) the operations of FIG. 5 in order to authenticate a designated user. In various embodiments, the primary user may be authenticated via the same or similar methods used to authenticate the designated user and described by operations 502-508 of FIG. 5.

As shown by operation 502, the apparatus 200 may include means, such as processor 202, memory 204, communications hardware 206, user authentication circuitry 210, and/or the like for identifying a smart mobile wallet (e.g., the second smart mobile wallet) associated with the designated user (e.g., the childcare provider). In this regard, the user authentication circuitry 210 may be configured to identify the second smart mobile wallet that is ostensibly associated with the designated user based on user attribute data corresponding to the designated user. By way of continued example, the FLSA share request may comprise user attribute data associated with the childcare provider (e.g., the designated user), and the user authentication circuitry 210 may be configured to identify the second smart mobile wallet inferred to be associated with the childcare provider based on the corresponding user attribute data. For instance, the user authentication circuitry 210 may be configured to leverage the communications hardware 206 to transmit a query to the second user device (e.g., user device 108B) associated with the designated user (e.g., the childcare provider) based on the user attribute data associated with the designated user and await an affirmative response indicating that the second smart mobile wallet is indeed associated with the user device (e.g., user device 108B) of the designated user.

As shown by operation 504, the apparatus 200 may include means, such as processor 202, memory 204, communications hardware 206, user authentication circuitry 210, and/or the like for transmitting a designated user identification data request to the smart mobile wallet (e.g., the second smart mobile wallet) associated with the designated user. For example, once the user authentication circuitry 210 identifies the second smart mobile wallet associated with the designated user (e.g., the childcare provider), the user authentication circuitry 210 may be configured to leverage the communications hardware 206 to transmit the designated user identification data request to the second smart mobile wallet. In various embodiments, the designated user identification data request is a request for one or more portions of data that may be utilized to authenticate the designated user (e.g., the childcare provider).

As shown by operation 506, the apparatus 200 may include means, such as processor 202, memory 204, communications hardware 206, and/or the like for receiving designated user identification data. For example, the communications hardware 206 may receive the designated user identification data from the second smart mobile wallet based on the designated user identification data request. By way of continued example, the designated user identification data may comprise cryptographic information associated with one or more of the second mDL or a second user device (e.g., user device 108B) associated with the childcare provider (e.g., the designated user). For instance, the second mDL of the childcare provider may be stored by the second smart mobile wallet, and the second smart mobile wallet may cause transmission (e.g., via the second user device (e.g., user device 108B)) of a public key associated with the second mDL to the apparatus 200 as part of the designated user identification data provided in response to the designated user identification data request. Additionally or alternatively, the second smart mobile wallet of the childcare provider (e.g., the designated user) may transmit cryptographic information (e.g., a public key) and/or other user device identification data associated with the second user device (e.g., user device 108B) to the apparatus 200 as part of the designated user identification data provided in response to the designated user identification data request.

As shown by operation 508, the apparatus 200 may include means, such as processor 202, memory 204, mDL management circuitry 208, user authentication circuitry 210, and/or the like for verifying that the smart mobile wallet (e.g., the second smart mobile wallet) is associated with the designated user. By way of continued example, the user authentication circuitry 210 may be configured to leverage the mDL management circuitry 208 to verify that the second smart mobile wallet is associated with the childcare provider (e.g., the designated user) based on the designated user identification data transmitted from the second user device (e.g., user device 108B). For instance, the user authentication circuitry 210 may be configured to verify that the second smart mobile wallet is associated with the childcare provider (e.g., the designated user) based on data associated with the second mDL comprised in the second smart mobile wallet indicated by the designated user identification data. Further details related to example implementations of operation 508 will be described herein with reference to FIG. 6.

Turning next to FIG. 6, a flowchart is provided that illustrates example operations for authenticating a designated user based on an mDL authentication request. As described herein, FIG. 6 illustrates some example implementations of operation 508 described herein with reference to FIG. 5. In some embodiments, the operations of FIG. 6 may be performed in response to the successful authentication of a primary user. For example, in some embodiments, once the primary user has been authenticated based on the first mDL comprised in the first mobile smart wallet associated the primary user, the user authentication circuitry 210 may be configured to facilitate (e.g., initiate, execute, manage) the operations of FIG. 6 in order to authenticate a designated user. In various embodiments, the primary user may be authenticated via the same or similar methods used to authenticate the designated user and described by operations 602-610 of FIG. 6.

As shown by operation 602, the apparatus 200 may include means, such as processor 202, memory 204, user authentication circuitry 210, and/or the like for executing an mDL authentication request associated with the designated user. The mDL authentication request is a request to authenticate the second mDL stored in the second smart mobile wallet associated with the designated user. In some embodiments, the mDL authentication request may be initiated, triggered, and/or executed based on the FLSA share request received from the first user device (e.g., user device 108A) associated with the primary user. In some embodiments, the user authentication circuitry 210 may be configured to facilitate the execution of the mDL authentication request based on or more data features associated with the mDL authentication request. For example, in some embodiments, the mDL authentication request may comprise one or more of designated user identification data (e.g., cryptographic information associated with an mDL and/or a user device) associated with the designated user (e.g., the childcare provider), desired credential data associated with the second mDL (e.g., a part particular request may indicate a need for verification of particular user information or PII of the designated user, particular credential validity data, and/or the like), and/or the second user attribute data associated with the designated user.

As shown by operation 604, the apparatus 200 may include means, such as processor 202, memory 204, mDL management circuitry 208, and/or the like for generating a digital token associated with the designated user. In some embodiments, the mDL management circuitry 208 may be configured to generate a digital token based in part on the mDL authentication request. By way of continued example, the mDL management circuitry 208 may be configured to generate a digital token comprising cryptographic information (e.g., public key information) associated with the second mDL of the childcare provider (e.g., the designated user). Additionally, in some embodiments, the cryptographic information associated with the second mDL and comprised in the digital token may be user device identification data by which a user device (e.g., user device 108B) of the childcare provider (e.g., the designated user) may be uniquely identified.

As shown by operation 606, the apparatus 200 may include means, such as processor 202, memory 204, communications hardware 206, mDL management circuitry 208, and/or the like for transmitting the digital token to an IA system (e.g., IA system 110A). By way of continued example, the mDL management circuitry 208 may leverage the communications hardware 206 to transmit the digital token to an IA system (e.g., IA system 110A) associated with the IA that provisioned the second mDL to the designated user (e.g., the childcare provider) such that the IA system (e.g., IA system 110A) may decrypt the cryptographic information comprised in the digital token. In this manner, the IA system (e.g., IA system 110A) may authenticate (e.g., verify) one or more portions of credential data associated with the second mDL and/or one or more portions of user device identification data associated with the user device (e.g., user device 108B) of the childcare provider (e.g., the designated user).

In some examples, the mDL management circuitry 208 may determine that the IA that provisioned the second mDL to the designated user (e.g., the childcare provider) may not be the same IA that provisioned the first mDL to the primary user. As such, the smart mobile wallet management system 102 (e.g., by way of the mDL management circuitry 208) may be configured to determine a first IA system (e.g., IA system 110A) associated with the designated user, and a second IA system (e.g., IA system 110B) associated with the primary user, such that respective digital tokens generated based on respective mDL authentication requests are routed to the correct IA system. In this manner, the smart mobile wallet management system 102 can ensure the safe transmission of the respective digital tokens and the successful authentication of the respective users (e.g., the primary user and the designated user).

As shown by operation 608, the apparatus 200 may include means, such as processor 202, memory 204, communications hardware 206, and/or the like for receiving an mDL validity response. For example, the communications hardware 206 may receive the mDL validity response from the IA system (e.g., IA system 110A) associated with the IA that provisioned the second mDL to the designated user (e.g., the childcare provider). In various embodiments, the mDL validity response is generated based on the digital token associated with the designated user (e.g., associated with the second mDL and/or the user device associated with the designated user (e.g., user device 108B)). In some examples, the mDL validity response indicates verified credential data (e.g., desired credential data) associated with the second mDL indicated by the mDL authentication request. Furthermore, in some examples, the mDL validity response may also indicate verified user device identification data related to the second user device associated with the designated user (e.g., user device 108B).

As shown by operation 610, the apparatus 200 may include means, such as processor 202, memory 204, user authentication circuitry 210, and/or the like for authenticating the designated user based on the mDL validity response. By way of continued example, the user authentication circuitry 210 may be configured to authenticate the childcare provider (e.g., the designated user) based on the data comprised in the mDL validity response received from the IA system (e.g., one of IA systems 110A-110N). In this manner, the smart mobile wallet management system 102 may be configured to authenticate a designated user (e.g., the childcare provider) based on an mDL associated with the designated user (e.g., the second mDL comprised in the second mobile wallet associated with the designated user).

Turning back now to FIG. 4 and as shown by operation 410, the apparatus 200 may include means, such as processor 202, memory 204, user authentication circuitry 210, and/or the like for determining whether the primary user and/or the designated user have been successfully authenticated. For example, the user authentication circuitry 210 may be configured to determine, based on a first mDL validity response received based on the execution of a first mDL authentication request associated with the primary user, that the primary user has been successfully authenticated. Similarly, the user authentication circuitry 210 may be configured to determine, based on a second mDL validity response received based on the execution of a second mDL authentication request associated with the designated user, that the designated user has been successfully authenticated.

In some examples, if the user authentication circuitry 210 determines that both the primary user and the designated user have been successfully authenticated, the smart mobile wallet management system 102 may proceed to operation 414. Alternatively, if the user authentication circuitry 210 determines that one or more of the primary user or the designated user have not been successfully authenticated, the smart mobile wallet management system 102 may proceed to operation 412.

As shown by operation 412, the apparatus 200 may include means, such as processor 202, memory 204, communications hardware 206, user authentication circuitry 210, and/or the like for transmitting an authentication alert. In some examples, if the user authentication circuitry 210 determines that one or more of the primary user or the designated user have not been successfully authenticated, the user authentication circuitry 210 may be configured to generate an authentication alert. In various embodiments, the authentication alert may be an alert, notification, warning, advisory, and/or the like that indicates various data related to a failed user authentication attempt related to a primary user and/or a designated user. The authentication alert may comprise data related to a user that was not successfully authenticated (e.g., a designated user) including, but not limited to, user contact information, user account information, credential data (e.g., mDL data), user device identification data, timestamp data associated with the user authentication attempt, geolocation data associated with the user during a time in which the user authentication attempt was executed (e.g., as indicated by GPS data collected and/or generated by a user device), and/or enterprise data (e.g., software application instance data, payment account data, user transaction data, product and/or service data, and/or the like associated with an enterprise utilizing the smart mobile wallet management system 102).

In some examples, an authentication alert may be configured as a notification, email, text message, direct application message (e.g., via a software application instance associated with the smart mobile wallet management system 102), audio message (e.g., automated voice message), banner notification, and/or the like. The user authentication circuitry 210 may be configured to leverage the communications hardware 206 to transmit an authentication alert to one or more computing devices (e.g., one or more enterprise computing device 106A-106N, user devices 108A-108B, IA systems (110A-110N), and/or the like via a number of different communication methods over a communications network (e.g., communications network 104).

In this regard, the user authentication circuitry 210 may be configured to identify one or more individuals and/or one or more computing devices associated with said individuals to transmit the authentication alert to. For example, the user authentication circuitry 210 may be configured to identify one or more enterprise representatives associated with one or more respective enterprise computing device 106A-106N and cause transmission of an authentication alert to the one or more respective enterprise computing device 106A-106N. Additionally or alternatively, in the event that a designated user was not successfully identified, the user authentication circuitry 210 may be configured to cause transmission of an authentication alert to a user device (e.g., user devices 108A-108N) associated with the primary user that attempted to share an FLSA with the designated user. Additionally or alternatively, in examples in which a payment account associated with an FLSA is a joint account (e.g., a payment account associated with a primary user and a secondary user), the user authentication circuitry 210 may be configured to cause transmission of an authentication alert to multiple respective user devices associated with the users associated with the joint account (e.g., a user device 108A associated with the primary user and a user device 108C associated with the secondary user).

As shown by operation 414, the apparatus 200 may include means, such as processor 202, memory 204, communications hardware 206, smart mobile wallet management circuitry 212, and/or the like for providing the FLSA to the designated user (e.g., the childcare provider). In some embodiments, the smart mobile wallet management circuitry 212 may be configured to leverage the communications hardware 206 to provide the FLSA to both the first smart mobile wallet associated with the primary user and the second smart mobile wallet associated with the designated user. As described herein, the smart mobile wallet management circuitry 212 may be configured to generate and provide a software application instance associated with the smart mobile wallet management system 102 to a user device (e.g., user device 108B associated with the designated user) where the software application instance may be configured to enable a user (e.g., a primary user, designated user, and/or the like) to access a smart mobile wallet configured to manage one or more respective payment accounts, payment cards, mDLs, and/or FLSAs.

Once the FLSA is provided to the smart mobile wallet associated with the designated user, the designated user may utilize the FLSA in the same manner as any other payment method managed and/or integrated with the smart mobile wallet. As described herein, the FLSA may be associated with one or more digital payment cards (e.g., fashioned after a conventional debit card, credit card, and/or the like) that may be stored by and/or linked to the one or more smart mobile wallets and utilized to execute various transactions via a user device (e.g., user device 108A). In some embodiments, a digital payment card associated with an FLSA may be associated with a respective user (e.g., a primary user or a designated user) and may have a corresponding card number, expiration date, card verification value (CVV), and/or the like. In various examples, the designated user may be enabled to utilize the FLSA to make transactions via a user device (e.g., user device 108B) such as a smart phone or smart watch via a “tap-to-pay” method at a POS terminal associated with a merchant. Additionally or alternatively, the designated user may be enabled to utilize the FLSA to make purchases with online merchants via a web browser.

As described herein, an FLSA may be utilizable only in alignment with various predetermined conditions set forth by a primary user to whom the FLSA belongs. For example, an FLSA may be configured (e.g., generated and/or updated) based on a set of FLSA parameters including, but not limited to, one or more of a predetermined balance, a balance limit (e.g., maximum or minimum fund limit), an expiration date, an access time period (e.g., only usable within predefined hours, days, weeks), a recurring monetary deposit (e.g., a recurring monetary deposit to be made from the corresponding existing payment account based on a predetermined schedule), a withdrawal limit (e.g., a $200 withdrawal limit), a transaction geolocation restriction (e.g., only usable within a certain geolocation coordinate perimeter), a merchant restriction (e.g., only usable with approved merchants), FLSA alert parameters (e.g., low balance alerts, transaction occurrence alerts, unauthorized transaction attempt alerts), and/or a designated user visibility restriction (e.g., only certain information related to the FLSA may be viewable by the designated user).

In this regard and by way of continued example, the communications hardware 206 may be configured to receive an FLSA transaction request from a user device (e.g., user device 108B) associated with the designated user (e.g., the childcare provider), where the FLSA transaction request is generated based on a user interaction with a second smart mobile wallet (e.g., the second smart mobile wallet associated with the designated user). In one or more examples, the FLSA transaction request may be a request to withdraw funds from a respective FLSA in order to settle a transaction with a third-party merchant. The smart mobile wallet management circuitry 212 may be configured to determine, based on the FLSA transaction request, whether the third-party merchant is an approved third-party merchant. If the smart mobile wallet management circuitry 212 determines that the third-party merchant is an approved third-party merchant, the smart mobile wallet management circuitry 212 may be configured to execute, based on the FLSA transaction request, the transaction. In such embodiments, executing the transaction may comprise causing a transfer of an agreed-upon amount of currency from the existing payment account associated with the primary user (e.g., the payment account associated with the FLSA) to a second payment account associated with the approved third-party merchant.

Furthermore, once an FLSA has been provided to a designated user (e.g., provided to the second smart mobile wallet associated with the childcare provider), the smart mobile wallet management circuitry 212 may be configured to update, adjust, change, and/or otherwise manage the FLSA. In this regard, the communications hardware 206 may be configured to receive an FLSA update request from a user device associated with the primary user (e.g., user device 108A), where the FLSA update request may be generated based on a user interaction with a user interface associated with a smart mobile wallet (e.g., the first smart mobile wallet) associated with the primary user. In some examples, the FLSA update request is a request to update one or more FLSA parameters of a set of FLSA parameters associated with the FLSA. Non-limiting examples of an FLSA request may include an FLSA request configured to adjust an access time period associated with the FLSA, update the value of a recurring monetary deposit to the FLSA, change a withdrawal limit associated with the FLSA, update a merchant restriction (e.g., add or remove one or more approved merchants), adjust a designated user visibility restriction (e.g., update what information related to the FLSA that a designated user can see via their respective smart mobile wallet), and/or the like. As such, the smart mobile wallet management circuitry 212 may be configured to update the FLSA based on the FLSA update request.

In some embodiments, the smart mobile wallet management circuitry 212 may automatically update one or more instances of the FLSA provided to one or more smart mobile wallets based on the FLSA update request. For example, the smart mobile wallet management circuitry 212 may leverage the communications hardware 206 to transmit various commands to the second smart mobile wallet on the user device (e.g., user device 108B) associated with the designated user in order to update the provided FLSA such that the designated user may utilize the provided FLSA according to the updated FLSA parameters.

FIGS. 4-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example User Interfaces

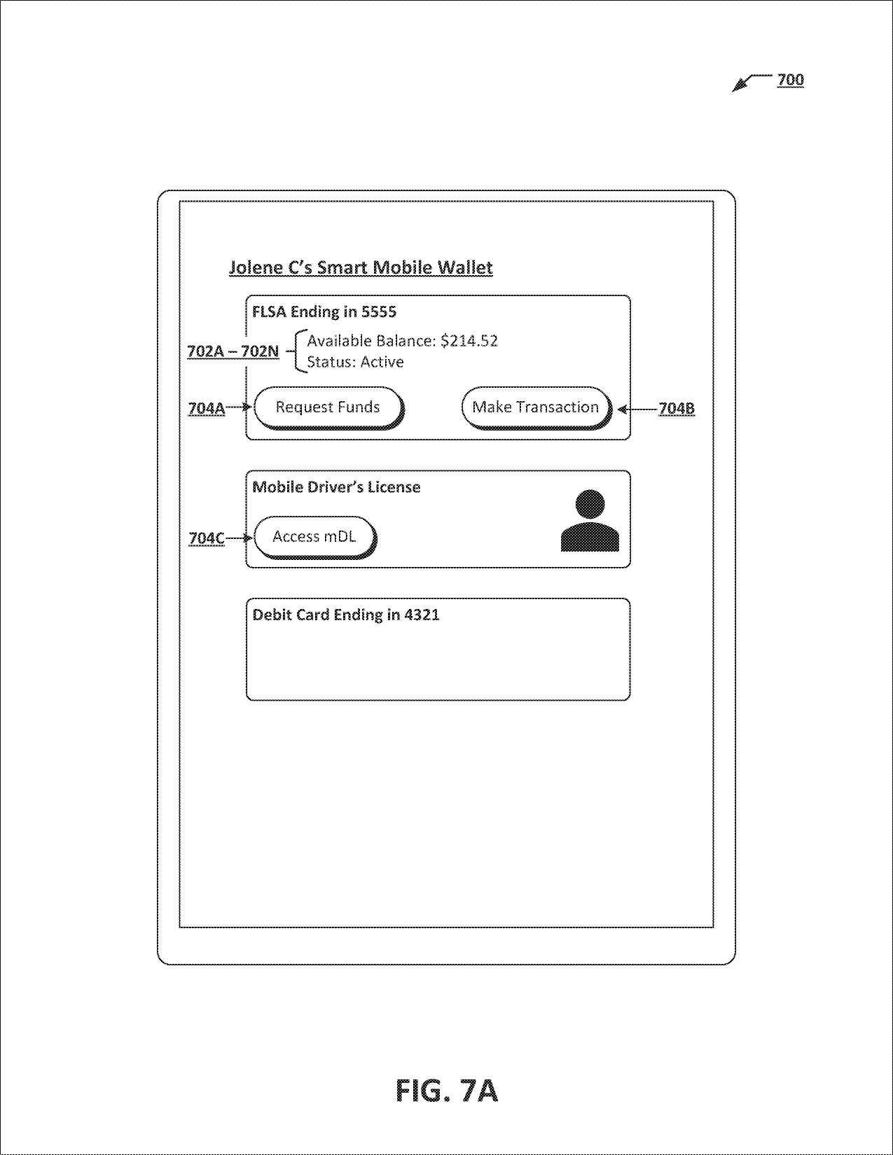

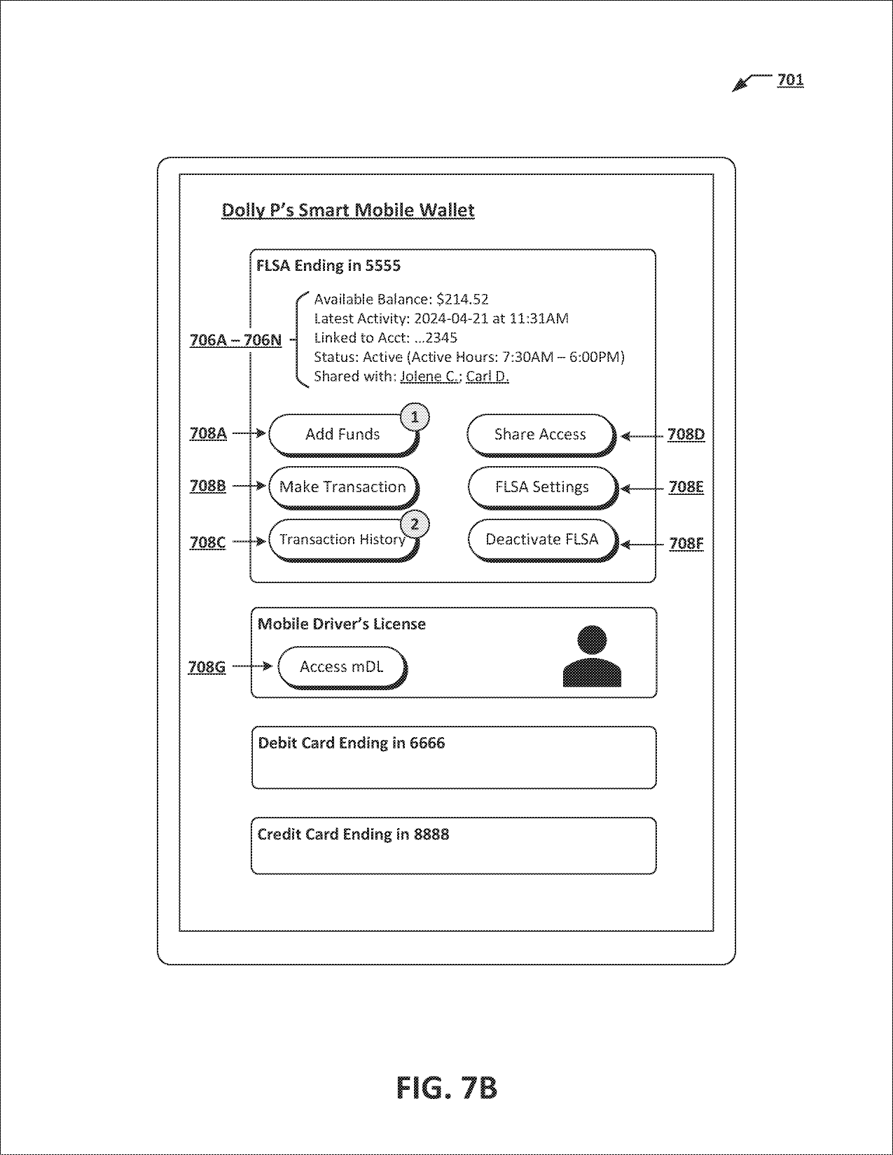

FIGS. 7A-7B depict example user interfaces corresponding to an example smart mobile wallet, access to which is enabled via a software application instance associated with the smart mobile wallet management system 102. Specifically, FIG. 7A illustrates an example user interface associated with a smart mobile wallet of a designated user (e.g., a childcare provider employed by a primary user), and FIG. 7B illustrates an example user interface associated with a smart mobile wallet of the primary user. It will be appreciated that various configurations and/or layouts of user interfaces associated with the smart mobile wallets and/or software application instances associated with the smart mobile wallet management system 102 may be developed. Accordingly, the examples depicted in FIGS. 7A-7B are provided for purposes of explanation and are not intended to limit the spirit and/or the scope of the present disclosure.

As described herein, a software application instance associated with the smart mobile wallet management system 102 may be configured to enable a user to access a smart mobile wallet (e.g., a digital wallet) configured to manage one or more of a user’s mDL, payment accounts (e.g., credit accounts, checking accounts, savings accounts, investment accounts), payment cards (e.g., credit cards, debit cards, and/or the like associated with the user’s payment accounts), and/or FLSAs that are associated with a respective enterprise employing the smart mobile wallet management system 102. In this regard, the smart mobile wallet management circuitry 212 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Turning now to FIG. 7A, an example user interface 700 associated with a smart mobile wallet of a designated user (e.g., a childcare provider employed by a primary user) is provided. The example user interface 700 may comprise one or more interactive user interface elements (e.g., interactive user interface elements 702A-702N and 704A-704C respectively), one or more digital representations of an FLSA (e.g., the FLSA ending in 5555), mDLs, payment cards, payments accounts, and/or the like.

As shown, the interactive user interface elements 702A-702N may be configured as text fields representative of various FLSA parameters associated with an FLSA (e.g., the FLSA ending in 5555). The interactive user interface elements 702A-702N may be configured based on a designated user visibility restriction associated with the FLSA (e.g., the FLSA ending in 5555). For example, in various embodiments, an FLSA may be configured such that only certain information related to the FLSA may be viewable by a designated user who has been granted access to the FLSA. For instance, as shown in FIG. 7A, the interactive user interface elements 702A-702N configured as text fields representative of various FLSA parameters associated with the FLSA (e.g., the FLSA ending in 5555) only provide limited information about the FLSA to the designated user (e.g., information related to an available balance and/or a current status associated with the FLSA ending in 5555).

The interactive user interface elements 704A-704C may be configured as interactive buttons that may be utilized to initiate various commands (e.g., executable software instructions) based one or more interactions (e.g., selections, indications, manipulations) with the interactive user interface elements 704A-704C. For example, the interactive user interface element 704A may be configured to initiate and/or transmit a funds request to a user device (e.g., user device 108A) of the primary user. The funds request may be a request for additional monetary funds to be deposited into an FLSA (e.g., the FLSA ending in 5555). The smart mobile wallet management circuitry 212 may be configured to leverage the communications hardware 206 to transmit the funds request to the user device associated with the primary user (e.g., user device 108A). Furthermore, the smart mobile wallet management circuitry 212 may be configured to cause display of the funds request via the smart mobile wallet associated with the primary user on the user device (e.g., user device 108A) associated with the primary user.

The interactive user interface element 704B may be configured to enable a user (e.g., the designated user) to initiate and/or complete a transaction. For example, in some embodiments, a user interaction with the interactive user interface element 704B may cause the smart mobile wallet to display a digital payment card associated with an FLSA (e.g., the FLSA ending in 5555) and/or enable the user device (e.g., user device 108B) associated with the designated user to authorize a purchase (e.g., by enabling to the user device to execute a tap-to-pay transaction authorization) at a POS terminal using funds from the FLSA. Additionally or alternatively, a user interaction with the interactive user interface element 704B and/or attempting to make a purchase at a POS terminal with the FLSA may cause the generation and/or transmission of an FLSA transaction request to the smart mobile wallet management system 102 for execution. As described herein, if the smart mobile wallet management circuitry 212 determines that a third-party merchant associated with the FLSA transaction request is an approved third-party merchant, the smart mobile wallet management circuitry 212 may be configured to execute, based on the FLSA transaction request, the transaction.

The interactive user interface element 704C may be configured to enable a user (e.g., the designated user) to access (e.g., view, manage, update, share, and/or the like) an mDL comprised in the smart mobile wallet associated with the designated user. In some examples, accessing the mDL via the interactive user interface element 704C may cause the display of one or more portions of credential data corresponding to the mDL associated with the designated user including, but not limited to, PII (e.g., given name, family name, name prefix, name suffix, driver’s license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver’s license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. As such, the smart mobile wallet may be configured to facilitate transactions requiring that the designated user provide proof of their identity (e.g., age-restricted transactions).

Turning now to FIG. 7B, an example user interface 701 associated with a smart mobile wallet of a primary user is provided. The example user interface 701 may comprise one or more interactive user interface elements (e.g., interactive user interface elements 706A-706N and 708A-708G respectively), one or more digital representations of an FLSA (e.g., the FLSA ending in 5555), mDLs, payment cards, payments accounts, and/or the like.

As shown, the interactive user interface elements 706A-706N may be configured as text fields representative of various FLSA parameters associated with an FLSA (e.g., the FLSA ending in 5555). For example, the interactive user interface elements 706A-706N may indicate various data associated with an FLSA (e.g., the FLSA ending in 5555) including, but not limited to, an available balance, a timestamp associated with the latest activity (e.g., transaction activity), a payment account identifier identifying the payment account to which the FLSA (e.g., the FLSA ending in 5555) is linked (e.g., the payment account ending in 2345), a current status (e.g., active, unactive), a predetermined access time period (e.g., a time period in which the FLSA is active), identifiers associated with the one or more users who have been granted access to the FLSA ending in 5555 (e.g., a designated user, Jolene C., and a secondary user, Carl D.), and/or the like associated with the FLSA (e.g., the FLSA ending in 5555).

The interactive user interface element 708A may be configured to enable a user (e.g., the primary user) to add funds to an FLSA (e.g., the FLSA ending in 5555). For example, in some embodiments, a user interaction with the interactive user interface element 708B may cause the smart mobile wallet to initiate a transfer of funds to the FLSA (e.g., the FLSA ending in 5555) from the payment account to which the FLSA is linked (e.g., the payment account ending in 2345). In various examples, the user interface 701 may be utilized to enter a custom amount of funds to transfer to the FLSA (e.g., the FLSA ending in 5555) from a specified payment account (e.g., the payment account ending in 2345 linked to the FLSA ending in 5555). Additionally, in some embodiments, interactive user interface element 708A may be flagged with a notification icon indicating that a funds request has been submitted by a user associated with the FLSA (e.g., a designated user or a secondary user).

The interactive user interface element 708B may be configured to enable a user (e.g., the primary user) to initiate and/or complete a transaction. For example, in some embodiments, a user interaction with the interactive user interface element 708B may cause the smart mobile wallet to display a digital payment card associated with an FLSA (e.g., the FLSA ending in 5555) and/or enable the user device (e.g., user device 108A) associated with the primary user to authorize a purchase (e.g., by enabling to the user device to execute a tap-to-pay transaction authorization) at a POS terminal using funds from the FLSA. Additionally or alternatively, a user interaction with the interactive user interface element 708B and/or attempting to make a purchase at a POS terminal with the FLSA may cause the generation and/or transmission of an FLSA transaction request to the smart mobile wallet management system 102 for execution.

The interactive user interface element 708C may be configured to view a transaction history associated with an FLSA (e.g., the FLSA ending in 5555). In some examples, accessing the transaction history via the interactive user interface element 708C may cause the display of data related to one or more recent transactions (e.g., payment transactions) for which funds from the FLSA (e.g., the FLSA ending in 5555) were used. The transaction history may comprise data including, but not limited to, timestamp data, merchant identification data, merchant location data, product and/or service description data, payment method data (e.g., tap-to-pay at POS terminal, online order, and/or the like), purchase price data, and/or the like. Additionally, in some embodiments, the interactive user interface element 708C may be flagged with a notification icon indicating that one or more new transactions (e.g., purchase transactions) associated with the FLSA (e.g., the FLSA ending in 5555) have been executed since the last time the transaction history of the FLSA was accessed by a user (e.g., the primary user).

The interactive user interface element 708D may be configured to enable a user (e.g., the primary user) to share an FLSA (e.g., the FLSA ending in 5555) with one or more additional users (e.g., additional designated users). In some embodiments, a user interaction with the interactive user interface element 708D may initiate one or more operations related to generating and/or transmitting an FLSA share request associated with the one or more additional designated users. As such, an interaction a user interaction with the interactive user interface element 708D may cause the smart mobile wallet management circuitry 212 to prompt the user (e.g., the primary user) to input one or more portions of user attribute data associated with the one or more additional designated users such as user profile data, user account data, user contact data, social media data, location data, and/or smart mobile wallet identification data associated with the designated user in order to generate an FLSA share request associated with the one or more additional designated users.

The interactive user interface element 708E may be configured to enable a user (e.g., the primary user) to manage (e.g., view, update, adjust, and/or the like) one or more settings and/or FLSA parameters associated with an FLSA (e.g., the FLSA ending in 5555). In some examples, a user interaction with the interactive user interface element 708E may initiate the generation and/or transmission of an FLSA update request to the smart mobile wallet management system 102, where the FLSA update request is a request to update one or more FLSA parameters of a set of FLSA parameters associated with the FLSA (e.g., the FLSA ending in 5555). Non-limiting examples of an FLSA request may include an FLSA request configured to adjust an access time period associated with the FLSA, update the value of a recurring monetary deposit to the FLSA, change a withdrawal limit associated with the FLSA, update a merchant restriction (e.g., add or remove one or more approved merchants), adjust a designated user visibility restriction (e.g., update what information related to the FLSA that a designated user can see via their respective smart mobile wallet), and/or the like. As such, the smart mobile wallet management circuitry 212 may be configured to update the FLSA based on the FLSA update request.

The interactive user interface element 708F may be configured to enable a user (e.g., the primary user) to deactivate an FLSA (e.g., the FLSA ending in 5555). In various embodiments, if a primary user deactivates an FLSA (e.g., the FLSA ending in 5555), the smart mobile wallet management system 102 may cause the denial of any subsequently attempted transactions made by any users associated with the FLSA such that no more purchases can be made using the FLSA and/or no more funds may be withdrawn or transferred from the FLSA.

The interactive user interface element 708G may be configured to enable a user (e.g., the primary user) to access (e.g., view, manage, update, share, and/or the like) an mDL comprised in the smart mobile wallet associated with the primary user. In some examples, accessing the mDL via the interactive user interface element 708G may cause the display of one or more portions of credential data corresponding to the mDL associated with the primary user.

### Conclusion

As described above, example embodiments provide methods and apparatuses that enable improved payment account sharing and access. Example embodiments thus provide tools (e.g., FLSAs) that overcome the problems faced by conventional payment mechanisms and techniques. By avoiding the use of conventional payment mechanisms and techniques, example embodiments thus save time and resources, while also eliminating the possibility of a user intentionally or unintentionally misusing monetary funds. Moreover, embodiments described herein counter a wide variety of emerging risks in an evolving technological landscape.

For instance, by providing a designated users access to an FLSA via a smart mobile wallet, example embodiments provide protection against the loss, theft, and/or misuse of conventional forms of payment (e.g., cash, checks, pre-paid debit cards, and/or the like). As such, by eliminating the need for conventional forms of payment, resource and material costs are significantly lowered for enterprises (e.g., financial institutions) in that there is no longer a need to manufacture, replace, or otherwise provide conventional forms of payment (e.g., plastic credit or debit cards, paper checks, and/or the like). Example embodiments also reduce the technical complexity of opening, closing, and/or managing a temporary account (e.g., bank account) for a designated user or secondary user on the behalf of a primary user. Example embodiments also provide the benefit of enabling a primary user (e.g., an owner of an FLSA) to enforce various rules, restrictions, and/or parameters related to how certain funds are spent by the designated user. As such, example embodiments provide additional layers of security for the funds associated with an FLSA and may be configured to ensure that said funds are only spent in accordance with the desires and requirements of a primary user.

Moreover, example embodiments contemplated herein provide technical solutions that solve real-world problems faced by users who wish to safely grant temporary access to funds to potentially unknown users (e.g., contract workers providing their services to a primary user) by employing various mDL-based user authentication techniques. And while confirming the identity of an individual has been a technical challenge for years, the increasing number of self-employed individuals using online-based marketing tools, online classifieds, and/or service aggregation websites has made this problem significantly more acute, especially as identity fraud and impersonation techniques become more sophisticated. By utilizing a legally issued mDL to authenticate a designated user, embodiments of the present disclosure ensure that designated users are properly verified before access to an FLSA is granted, thereby increasing the security and safety of the funds associated with the FLSA.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a flexible limit share account (FLSA), the method comprising:
receiving, by communications hardware, an FLSA generation request from a first user device associated with a primary user;
generating, by smart mobile wallet management circuitry and based on the FLSA generation request, an FLSA associated with an existing payment account of the primary user;
in response to generating the FLSA, receiving, by the communications hardware, an FLSA share request associated with the FLSA from the first user device, wherein the FLSA share request is a request to share access to the FLSA with a designated user;
authenticating, by user authentication circuitry and based on the FLSA share request, the primary user and the designated user based on a first mobile driver’s license (mDL) associated with the primary user and a second mDL associated with the designated user; and
in response to successfully authenticating the primary user and the designated user, providing, by the communications hardware, the FLSA to a second user device associated with the designated user.

2. The method of claim 1, wherein the FLSA share request comprises first user attribute data associated with the primary user, and wherein authenticating the primary user further comprises:
identifying, by the user authentication circuitry and based on the first user attribute data, a first smart mobile wallet associated with the primary user;
transmitting, by the communications hardware, a primary user identification data request to the first smart mobile wallet;
receiving, by the communications hardware and based on the primary user identification data request, primary user identification data, wherein the primary user identification data comprises cryptographic information associated with one or more of the first mDL or the first user device; and
verifying, by the user authentication circuitry and based on the primary user identification data, that the first smart mobile wallet is associated with the primary user.

3. The method of claim 2, wherein verifying the first smart mobile wallet is associated with the primary user further comprises:
executing, by mDL management circuitry and based on the FLSA share request, a first mDL authentication request, wherein the first mDL authentication request is a request to authenticate the first mDL associated with the primary user, and wherein authenticating the first mDL comprises:
generating, by the mDL management circuitry and based on the first mDL authentication request, a first digital token;
transmitting, by the communications hardware, the first digital token to an issuing authority (IA) system associated with an IA that provisioned the first mDL to the primary user; and
receiving, by the communications hardware and from the IA system, a first mDL validity response, wherein the first mDL validity response is generated based on the first digital token, and wherein the first mDL validity response indicates verified credential data associated with the first mDL; and
authenticating, by the user authentication circuitry, the primary user based on the first mDL validity response.

4. The method of claim 3, wherein the first mDL authentication request comprises one or more of the primary user identification data, desired credential data associated with the first mDL, or the first user attribute data associated with the primary user.

5. The method of claim 4, wherein the FLSA share request comprises second user attribute data associated with the designated user, and wherein authenticating the designated user further comprises:
in response to successfully authenticating the primary user:
identifying, by the user authentication circuitry and based on the second user attribute data, a second smart mobile wallet associated with the designated user;
transmitting, by the communications hardware, a designated user identification data request to the second smart mobile wallet;
receiving, by the communications hardware and based on the designated user identification data request, designated user identification data, wherein the designated user identification data comprises cryptographic information associated with one or more of the second mDL or a second user device associated with the designated user; and
verifying, by the user authentication circuitry and based on the designated user identification data, that the second smart mobile wallet is associated with the designated user.

6. The method of claim 5, wherein verifying the second smart mobile wallet is associated with the designated user further comprises:
executing, by the user authentication circuitry and based on the FLSA share request, a second mDL authentication request, wherein the second mDL authentication request is a request to authenticate the second mDL associated with the designated user, and wherein the second mDL authentication comprises:
generating, by the mDL management circuitry and based on the second mDL authentication request, a second digital token;
transmitting, by the communications hardware, the second digital token to an IA system associated with an IA that provisioned the second mDL to the designated user; and
receiving, by the communications hardware and from the IA system, a second mDL validity response, wherein the second mDL validity response is generated based on the second digital token, and wherein the second mDL validity response indicates verified credential data associated with the second mDL; and
authenticating, by the user authentication circuitry, the designated user based on the second mDL validity response.

7. The method of claim 6, wherein the second mDL authentication request comprises one or more of the designated user identification data, desired credential data associated with the second mDL, or the second user attribute data associated with the designated user.

8. The method of claim 7, wherein the first mDL validity response and the second mDL validity response further indicate verified user device identification data related to the first user device associated with the primary user and the second user device associated with the designated user respectively.

9. The method of claim 1, wherein the FLSA generation request comprises a set of FLSA parameters, wherein the FLSA is generated based on the set of FLSA parameters, and wherein the set of FLSA parameters comprises one or more of an FLSA identifier, an FLSA balance, an FLSA balance limit, an FLSA expiration date, an FLSA access time period, a recurring monetary deposit, an FLSA withdrawal limit, a transaction geolocation restriction, a merchant restriction, a recurring deposit period, FLSA alert parameters, or designated user visibility restrictions.

10. The method of claim 1, wherein the existing payment account of the primary user is further associated with a secondary user, the method further comprising:
in response to receiving the FLSA generation request from the first user device associated with the primary user:
providing, by the communications hardware, an FLSA generation permission request to a third user device associated with the secondary user, wherein the FLSA generation permission request is a request to authorize generation of the FLSA associated with the existing payment account;
receiving, by the communications hardware, an affirmative FLSA generation permission request response from the third user device; and
generating, by the smart mobile wallet management circuitry and based on the affirmative FLSA generation permission request response, the FLSA associated with the existing payment account.

11. The method of claim 1, the method further comprising:
receiving, by the communications hardware, an FLSA update request from the first user device associated with the primary user, wherein the FLSA update request is generated based on an interaction with a user interface associated with the first smart mobile wallet, and wherein the FLSA update request is a request to update one or more FLSA parameters of a set of FLSA parameters associated with the FLSA; and
updating, by the smart mobile wallet management circuitry, the FLSA based on the FLSA update request.

12. The method of claim 1, the method further comprising:
receiving, by the communications hardware, an FLSA transaction request from the second user device associated with the designated user, wherein the FLSA transaction request is generated based on an interaction with a second smart mobile wallet associated with the designated user, and wherein the FLSA transaction request is a request to withdraw funds from the FLSA in order to settle a transaction with a third-party merchant;
determining, by the smart mobile wallet management circuitry and based on the FLSA transaction request, whether the third-party merchant is an approved third-party merchant; and
in response to determining that the third-party merchant is an approved third-party merchant:
executing, by the smart mobile wallet management circuitry and based on the FLSA transaction request, the transaction, wherein executing the transaction comprises causing a transfer of an agreed-upon amount of currency from the existing payment account associated with the primary user to a second payment account associated with the approved third-party merchant.

13. An apparatus for providing a flexible limit share account (FLSA), the apparatus comprising:
communications hardware configured to:
receive an FLSA generation request from a first user device associated with a primary user;
smart mobile wallet management circuitry configured to:
generate, based on the FLSA generation request, an FLSA associated with an existing payment account of the primary user,
wherein the communications hardware is configured to receive an FLSA share request associated with the FLSA from the first user device, and wherein the FLSA share request is a request to share access to the FLSA with a designated user; and
user authentication circuitry configured to:
authenticate, based on the FLSA share request, the primary user and the designated user based on a first mobile driver’s license (mDL) associated with the primary user and a second mDL associated with the designated user,
wherein the communications hardware is configured to provide the FLSA to a second user device associated with the designated user in response to the user authentication circuitry successfully authenticating the primary user and the designated user.

14. The apparatus of claim 13, wherein the FLSA share request comprises first user attribute data associated with the primary user, and wherein authenticating the primary user further comprises:
identifying, by the user authentication circuitry and based on the first user attribute data, a first smart mobile wallet associated with the primary user;
transmitting, by the communications hardware, a primary user identification data request to the first smart mobile wallet;
receiving, by the communications hardware and based on the primary user identification data request, primary user identification data, wherein the primary user identification data comprises cryptographic information associated with one or more of the first mDL or the first user device; and
verifying, by the user authentication circuitry and based on the primary user identification data, that the first smart mobile wallet is associated with the primary user.

15. The apparatus of claim 14, wherein verifying the first smart mobile wallet is associated with the primary user further comprises:
executing, by mDL management circuitry and based on the FLSA share request, a first mDL authentication request, wherein the first mDL authentication request is a request to authenticate the first mDL associated with the primary user, and wherein authenticating the first mDL comprises:
generating, by the mDL management circuitry and based on the first mDL authentication request, a first digital token;
transmitting, by the communications hardware, the first digital token to an issuing authority (IA) system associated with an IA that provisioned the first mDL to the primary user; and
receiving, by the communications hardware and from the IA system, a first mDL validity response, wherein the first mDL validity response is generated based on the first digital token, and wherein the first mDL validity response indicates verified credential data associated with the first mDL; and
authenticating, by the user authentication circuitry, the primary user based on the first mDL validity response.

16. The apparatus of claim 15, wherein the first mDL authentication request comprises one or more of the primary user identification data, desired credential data associated with the first mDL, or the first user attribute data associated with the primary user.

17. The apparatus of claim 16, wherein the FLSA share request comprises second user attribute data associated with the designated user, and wherein authenticating the designated user further comprises:
in response to successfully authenticating the primary user:
identifying, by the user authentication circuitry and based on the second user attribute data, a second smart mobile wallet associated with the designated user;
transmitting, by the communications hardware, a designated user identification data request to the second smart mobile wallet;
receiving, by the communications hardware and based on the designated user identification data request, designated user identification data, wherein the designated user identification data comprises cryptographic information associated with one or more of the second mDL or a second user device associated with the designated user; and
verifying, by the user authentication circuitry and based on the designated user identification data, that the second smart mobile wallet is associated with the designated user.

18. The apparatus of claim 17, wherein verifying the second smart mobile wallet is associated with the designated user further comprises:
executing, by the user authentication circuitry and based on the FLSA share request, a second mDL authentication request, wherein the second mDL authentication request is a request to authenticate the second mDL associated with the designated user, and wherein the second mDL authentication comprises:
generating, by the mDL management circuitry and based on the second mDL authentication request, a second digital token;
transmitting, by the communications hardware, the second digital token to an IA system associated with an IA that provisioned the second mDL to the designated user; and
receiving, by the communications hardware and from the IA system, a second mDL validity response, wherein the second mDL validity response is generated based on the second digital token, and wherein the second mDL validity response indicates verified credential data associated with the second mDL; and
authenticating, by the user authentication circuitry, the designated user based on the second mDL validity response.

19. The apparatus of claim 18, wherein the first mDL validity response and the second mDL validity response further indicate verified user device identification data related to the first user device associated with the primary user and the second user device associated with the designated user respectively.

20. A computer program product for providing a flexible limit share account (FLSA), the computer program product comprising at least one non-transitory computer-readable storage medium storing software instructions that, when executed, cause an apparatus to:
receive an FLSA generation request from a first user device associated with a primary user;
generate, based on the FLSA generation request, an FLSA associated with an existing payment account of the primary user;
receive an FLSA share request associated with the FLSA from the first user device, wherein the FLSA share request is a request to share access to the FLSA with a designated user;
authenticate, based on the FLSA share request, the primary user and the designated user based on a first mobile driver’s license (mDL) associated with the primary user and a second mDL associated with the designated user; and
provide the FLSA to a second user device associated with the designated user in response to successfully authenticating the primary user and the designated user.
